(19) United States
(12) Patent Application Publication
(10) Pub. No.: US 2012/0001112 A1
(43) Pub. Date: Jan. 5, 2012

(54) APPARATUS AND METHOD FOR EXTRACTION OR ADDITION OF SUBSTANCES FROM OR TO A BODY OF LIQUID

(76) Inventors: Patrick William Alkemade, Victoria (AU); Brent Shellcot, Queensland (AU)

(21) Appl. No.: 12/452,830

(22) PCT Filed: Jul. 24, 2008
(86) PCT No.: PCT/AU2008/001076

§ 371 Date: Jul. 19, 2010

Related U.S. Application Data
(60) Provisional application No. 60/935,114, filed on Jul. 26, 2007.
(60) Provisional application No. 60/935,222, filed on Aug. 1, 2007.
(60) Provisional application No. 60/935,266, filed on Aug. 2, 2007.

(51) Int. Cl. F16K 1/00

(52) U.S. Cl. 251/318

(57) ABSTRACT

Apparatus, methods, and systems are provided for separating substances from a container or body of fluid. The apparatus comprises a body containing a flow-through passageway adapted to attach to the flow-through passageway; an assembly adapted to selectively seal the flow through passageway; and a reservoir in communication with flow-through passageway; wherein the reservoir is configured to cause the assembly to unseal the flow-through passageway when the reservoir is attached to the flow-through passageway

### CROSS-REFERENCE TO RELATED APPLICATIONS

The present application is related to co-pending patent application PCT/AU2006/001291, and U.S. provisional application Improved Apparatus And Method For Extraction Or Addition Of Substances From Or To A Body Of Liquid filed on Jul. 26, 2007. The entire content of these applications is hereby incorporated by reference.

### BACKGROUND

Means for separating substances from fluids have been employed in a wide variety of fluidic applications including brewing of alcoholic beverages, hydraulic systems, fuel systems, and engine lubrication systems. For example, brewing of beer, wine, and other bottle-conditioned alcoholic beverages, i.e., beverages which are fermented, aged and naturally carbonated in the bottle may require the removal or addition of substances from the product. In the fermentation process used to prepare such beverages, yeast causes sugars in the liquid to ferment into carbon dioxide (CO₂) and ethyl alcohol (C₂H₆O). During fermentation, the carbon dioxide may cause a relatively high pressure to build-up, in some cases up to 12 atmospheres. There are also various unwanted by-products of fermentation that vary according to the chemical composition of the liquid and the rate and manner of fermentation. These by-products either dissolve in the wine or precipitate as sediments. Various methods have been employed to remove excess carbon dioxide and unwanted by-products from the beverage or to add products to the beverage.

In the case of making sparkling wine, for example, the bottle may be inverted or turned upside down to allow the sediment to collect in the tip region of the neck of the bottle. The bottle neck may then be placed in a freezing brine solution until the liquid in the tip region is frozen solid. The bottle may then be warmed slightly to loosen the frozen sediment plug, after which the bottle cap is removed and the pressure of the natural carbonation blows the sediment plug out of the bottle. Then the bottle may be recapped. This method, however, is complicated and time-consuming.

In the case of home-brewed beer, for example, if the sediment has not yet been removed at the time the beer is to be consumed, the beer may be poured carefully into a glass in one motion until the sediment begins moving from the bottom of the bottle. As another example, some wines (e.g., red wines) that have a tendency to accumulate sediment as they age may be similarly decanted. A problem with this approach is that it is aesthetically undesirable to drink or to serve guests a beverage which has an unappetizing deposit sitting on the bottom of the bottle or which has become turbid in the glass as the liquid was being poured into the glass. To avoid this possibility, it is necessary to handle the bottle very carefully so as not to agitate the liquid and stir up the sediment, but that requires a great deal of concentration as well as a steady hand and is also very slow.

In other applications, fluid filters may include fuel/water separators or sediment pots. In a fuel/water separator, water and sediments such as dirt, sand and grit are separated from a fuel/water mixture, in order to prevent damage to downstream engine components. Fluid filters which remove water will tend to accumulate the separated water and sediment by gravity at the bottom of the housing. The water should eventually be removed from the housing. Some models of liquid filters incorporate a mechanism to remove the water from the housing by using a pipe plug or a petcock. Often, the device begins to drain fluid as soon as it becomes unseated or loosened. The leaking fluid may run onto the operator's hand and down the arm as the device is turned the additional revolutions to the open, or separated, position. When the mechanism is to be closed, the operator is exposed to the fluid as the threaded shaft or plug is rotated several turns before it becomes closed or seated.

For the foregoing reasons, it is desirable to have a superior apparatus, method and system for extracting substances than what is presently available.

### SUMMARY

The present disclosure is directed to an apparatus, method and system that may satisfy this need and provide numerous other advantages as described below.

In certain embodiments, the apparatus comprises a body containing a flow-through passageway adapted to attach to the flow-through passageway; an assembly adapted to selectively seal the flow through passageway; and a reservoir in communication with flow-through passageway; wherein the reservoir is configured to cause the assembly to unseal the flow-through passageway when the reservoir is attached to the flow-through passageway.

In certain embodiments, the apparatus comprises a body containing a flow-through passageway adapted to sealably attach a proximal end of the flow-through passageway to an orifice; a stopper assembly contained within the flow-through passageway adapted to selectively seal the flow through passageway; and a reservoir adapted to sealably attach to a distal end of the flow-through passageway; wherein the reservoir is configured to cause the stopper assembly to unseal the flow-through passageway when the reservoir is sealably attached to the distal end of the flow-through passageway.

In certain embodiments, the apparatus comprises a body containing a flow-through passageway adapted to sealably attach a proximal end of the flow-through passageway to an orifice of a container, a stopper assembly contained within the flow-through passageway adapted to selectively seal the flow through passageway; and a reservoir adapted to sealably attach to a distal end of the flow-through passageway; wherein the reservoir is configured to cause the stopper assembly to unseal the flow-through passageway when the reservoir is sealably attached to the distal end of the flow-through passageway; and wherein the reservoir supports the weight of the container so that the container is maintained in an inverted position.

In certain embodiments, the apparatus comprises a body containing a flow-through passageway adapted to sealably attach a proximal end of the flow-through passageway to an orifice of a container; a stopper assembly means for selectively sealing the flow through passageway; a reservoir means for causing the stopper assembly to unseal the flow-through passageway when the reservoir means is sealably attached to the distal end of the flow-through passageway and for supporting the weight of the container so that the container is maintained in an inverted position.

In certain embodiments, the apparatus comprises a body containing a flow-through passageway; an assembly means for selectively sealing the flow through passageway; a reservoir means for causing the assembly to unseal the flow-through passage way when the reservoir means in communication with the flow-through passageway passageway.

In certain embodiments, the apparatus comprises an assembly having a member adapted to attach to the mouth of a container and a skirt adapted to communicate with a portion of a base, wherein substances, fluids, sediments, or combinations thereof may settle into the apparatus from the liquid in the container when the apparatus is in an open position or substantially opened position, wherein the container may be sealed from the apparatus, and wherein the base is configured to support or partially support the container. In certain aspects the container and the skirt is adapted to fit tightly within a portion of a removable base, and the container may be sealed by locking, or substantially locking, the apparatus into a closed position, and the removable base is configured to support, or substantially support the weight of the container in an inverted position.

In certain embodiments, the apparatus comprises a bottle cap assembly having a capping member adapted to attach to the mouth of a bottle and a skirt adapted to fit tightly within a portion of a removable base, wherein sediment may settle into the apparatus from the wine whilst the apparatus is in an open position, wherein the bottle may be sealed by locking the apparatus into a closed position, and wherein the removable base is configured to support the weight of the bottle in an inverted position.

Certain embodiments of the disclosure may be used to separate substances, fluids sediments, or combinations thereof from a beverage such as beer or wine. Certain embodiments may also be used to add substances, fluids, or combinations thereof to a beverage such as beer, wine, other alcohols, other liquid systems. Certain embodiments may be used to separate liquids (such as water) and/or sediments (such as sand, grit, or dirt) from a fuel, oil, or other hydrocarbon-based liquid.

Certain embodiments may be used to separate substances, fluids, sediments, or combinations thereof from a liquid.

Certain embodiments may be used to separate substances, fluids, sediments, or combinations thereof from liquids wherein the substances, fluids, sediments or combinations thereof have a different density from a liquid.

Certain embodiments may be used to separate substances, fluids, sediments, or combinations thereof from a liquid wherein the substances, fluids, sediments or combinations thereof have a different density and/or different immiscibility from the liquid.

Certain embodiments may be used to separate substances, fluids, sediments, or combinations thereof from a liquid wherein the substances, fluids, sediments or combinations thereof have a different immiscibility from the liquid. In addition, methods and systems are disclosed that use any of the above apparatus to remove substances, fluids, sediments, or combinations thereof from a liquid.

### BRIEF DESCRIPTION OF THE DRAWINGS

These and other features, aspects, and advantages of the present invention will become better understood with regard to the following description, appended claims, and accompanying drawings where:

FIG. 1 is a section through the removal assembly according to certain embodiments prior to actuation of the valve;

FIG. 2 illustrates, according to certain embodiments, removal of sediment with the container inverted and the valve actuated;

FIG. 3 is a drawing illustrating, according to certain embodiments, removal of the valve actuator and reservoir;

FIG. 4 is a drawing illustrating, according to certain embodiments, cleaning of the valve actuator by removal of sediment and liquid from the valve actuator;

FIG. 5 is an exploded drawing illustrating, according to certain embodiments, the valve body, its return spring and a ring seal;

FIGS. 6 and 7 illustrate, according to certain embodiments, an assembly as applied to a wine bottle and beer bottle respectively; and

FIGS. 8 and 9 illustrate, according to certain embodiments, an assembly as applied to a bottle.

FIGS. 10A and 10B illustrate a side view and a bottom view respectively of a detachable assembly or safety valve according to certain embodiments.

FIG. 11 illustrates a cutaway view of a sediment pot or separating tank according to certain embodiments.

FIG. 12 illustrates a cutaway view of a sediment pot or separating tank according to certain embodiments.

FIG. 13 illustrates the operation of a sediment pot or separating tank according to certain embodiments.

FIG. 14 illustrates an exemplary view of a sediment pot or separating tank according to certain embodiments.

FIGS. 15A and 15B illustrate exemplary views of a sediment pot or separating tank according to certain embodiments.

FIG. 16A illustrates a side view of the assembly according to certain embodiments.

FIG. 16B illustrates a cutaway view of the assembly according to certain embodiments.

FIG. 16C illustrates an isometric top view of the assembly according to certain embodiments.

FIG. 17 illustrates cutaway view of the assembly according to certain embodiments.

FIG. 18A illustrates a cutaway view of the assembly according to certain embodiments.

FIG. 18B illustrates a cutaway view of the assembly according to certain embodiments.

FIGS. 19A to 19F illustrate various views of a body of the assembly according to certain embodiments.

FIGS. 20A to 20D illustrate various views of a valve assembly according to certain embodiments.

FIGS. 21A to 21D illustrate various views of a sealing ring of the assembly according to certain embodiments.

FIGS. 22A and 22B illustrate bottom views of the reservoir of the assembly according to certain embodiments.

FIG. 23 illustrates a top view of the reservoir of the assembly according to certain embodiments.

FIGS. 24A to 24E illustrate various views of the reservoir of the assembly according to certain embodiments.

FIG. 25 illustrates a cutaway view of the reservoir of the assembly according to certain embodiments.

FIGS. 26A and B illustrate a side view of the apparatus according to certain embodiments.

FIG. 27 illustrates a side view of the apparatus according to certain embodiments.

FIG. 28 illustrates a side view of the apparatus according to certain embodiments.

FIG. 29 illustrates a side view of the apparatus according to certain embodiments.

FIG. 30 illustrates a cutaway side view of the apparatus according to certain embodiments.

FIG. 31 illustrates an isometric view of the apparatus according to certain embodiments.

FIG. 32 illustrates a cutaway side view of the apparatus in the open position according to certain embodiments.

FIG. 33 illustrates a cutaway side view of the apparatus in the closed position according to certain embodiments.

FIGS. 34A to F illustrate the operation of the apparatus according to certain embodiments.

FIG. 35 illustrates a cutaway side view of the apparatus according to certain embodiments.

FIGS. 36A to D illustrate various views of the pieces of a bottle cap assembly according to certain embodiments.

FIG. 37 illustrates the operation of the bottle cap assembly according to certain embodiments.

FIG. 38 illustrates a side view of the apparatus attached to a bottle according to certain embodiments.

### DESCRIPTION

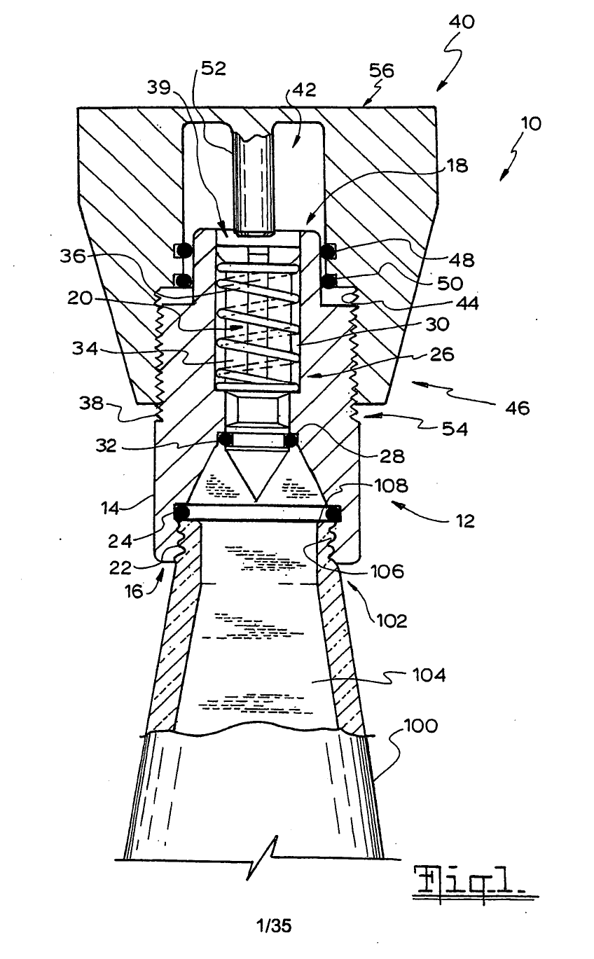

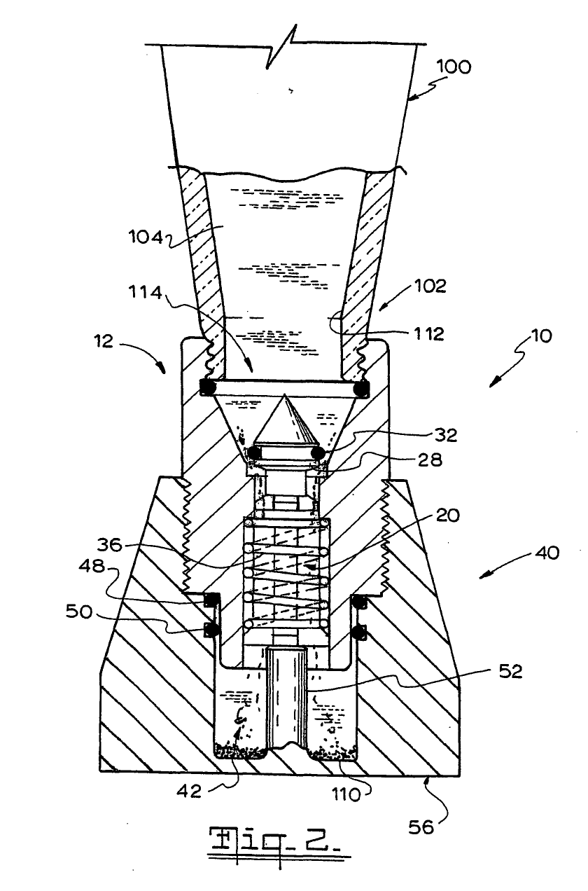

In certain embodiments illustrated in FIGS. 1 and 2, an apparatus 10 for removing substances from a liquid is shown. The apparatus comprises a body 14 with opposite ends 16 and 18 and a flow-through passageway 20 between those ends; an assembly 26 within the flow-through passageway 20 configured to selectively seal and unseal the flow-through passageway; and a reservoir 40 connected to the flow-through passageway 20. In certain embodiments, the assembly 26 may be a stopper assembly.

Certain embodiments are used to remove substances, materials, liquids, gases or combination of the above from a body of liquid.

The body 14 may be configured to be sealably attached to an orifice 108. For example, as illustrated in FIG. 1, the body 14 may be attached to the top 102 of a container 100 containing a beverage 104. The orifice 108 may also be the open end of, for example, a bottle, nozzle, hose, some structure capable of containing fluid, or other suitable container. The end 16 of the flow-through passageway 20 nearest the orifice 108 may also be referred to as the proximal end and the opposite end 18 may be referred to as the distal end.

The proximal end 16 may be mated to the orifice 108 in various ways. For example, as shown in FIG. 1, the proximal end 16 may have an internal screw threaded portion 22 that is configured to threadably attach to an external screw thread portion 106 of a bottle 100 with a seal member 24. The seal member 24 may be any suitable sealing device that is capable of providing the desired level of sealing, for example, but not limited to, an o-ring, x-ring or other gasket. When engaged, the screw threaded portion 22 may force the sealing member 24 into sealing engagement against the rim 108 of the container 100. Alternatively, any suitable means for attaching the proximal end 16 to the exterior portion of the orifice may be used. For example, but not limited to, a pushfit, clamp, clip, bayonet, swivel fitting, or other fastener. In the case of a non-screw thread bottle, the seal comprising the o-ring 24 may be applied by a further spring located in the seal and that portion comprising the internal thread 22 of the seal may comprise hinge members which fit around the lip of the bottle so that a spring is used to apply the seal 24 to the bottle. In certain embodiments, the sealing arrangements may be useful in particular for fluids that have or generate dissolved gases and thus create or generate additional pressures, e.g., carbonated fluids or sparkling wines. In an alternative embodiment, the proximal end 16 could consist of a plug, insert, or other suitable means adapted to sealably mate with the interior portion of the orifice 108. In certain embodiments other suitable combinations of interior and exterior mating could be used.

The body may be any suitable shape. For example, in certain embodiments, the body 14 may be cylindrical as show in FIGS. 1 and 2. In alternative embodiments, the body could be square, triangular, oval or any other shape. The body 14 could be segmented, for example, it could be composed of two or more pieces joined together either fixedly or removably. In some embodiments, the body 14 could be formed to provide a stable base for the apparatus. For example, in a bottle brewing application, the body 14 could be wide and flat or provide legs to support an inverted bottle attached to the apparatus 10.

The body 14 may be constructed of any suitable material or combinations of materials. For example, the body 14 could be made of a transparent, translucent or opaque polymeric material such as acrylic, epoxy resin, phenolic resin, fluoroplastic, nylon, rubber, plastic, polyvinylchloride, Terlux®, Xylex™, or polystyrene (e.g., Styrofoam). In certain embodiments, constructing the body 14 of transparent or translucent materials could advantageously enable visual inspection of the operation of the apparatus 10. Alternatively, the body could be made of other materials, for example, a plastic or polymeric material such as Terlux®, or Xylex™; metal such as steel, iron or copper; a wood such as pine or oak; a mineral such as glass, silicon, or quartz; or a ceramic or any desired combination of materials. Porous materials could be sealed with resin, wax or other suitable sealant to prevent or minimize leakage. The body 14 may be sterilizable to allow repeated use. The body 14 may also be disposable so that it could be cheaply and easily manufactured. The body may be any suitable size. For example, between 0.1 inches and 4 inches, between 0.25 inches and 3 inches, between half an inch and 4 inches in diameter and between half an inch and 6 inches, between 1 inch and 4 inches, or between 2 inches and 4 inches in length.

In an exemplary embodiment illustrated in FIG. 1, the stopper assembly 26 within the flow-through passageway 20 may comprise a valve seat 28 that cooperates with a valve member 30 having a seal member 32 carried on a valve body 34. The valve body 34 may be held in the substantially closed or closed position by a biasing spring 36. Thus, the seal member 32 and the seal member 24 may cooperate to seal the container 100 when the valve member 30 is closed. Alternatively, the stopper assembly 26 could be maintained in the normally shut position by the force of gravity pushing the valve assembly. In this alternative aspect, when the body 14 is attached to a bottle containing a liquid and maintained in an inverted position, the force of the liquid will provide additional pressure on the stopper assembly 26, thereby maintaining a tight seal.

In certain embodiments, the assembly can be anything that will permit the flow of fluid to be shut off, substantially shut off, or substantially reduced. In other embodiments, the assembly can be any means that permits the flow of fluid to be shut off, substantially shut off, or substantially reduced. For example, this could be any type of valve, such as a ball-valve, gate-valve, butterfly valve, globe valve, or needle valve. Moreover, the assembly could be any other type of flow shutoff mechanism such as a plunger, diaphragm, or sphincter. In still other embodiments, the stopper assembly 26 could be electrically or magnetically actuated, for example as in a solenoid valve. In certain embodiments, the assembly could be combinations of various ways for shutting off or restricting the flow of fluids.

The assembly 26 may be constructed of any suitable material or combinations of materials. Typically, the assembly 26 could be made of a metal such as steel, iron, aluminum, tin or copper. However, it could alternatively be made of a wood such as pine or oak; a mineral such as glass, silicon, or quartz; or a ceramic. It could also be made of polymeric material such as acrylic, epoxy resin, phenolic resin, fluoroplastic, nylon, rubber, plastic, polyvinylchloride, polystyrene, Terlux®, or Xylex™. Porous materials, e.g., wood or ceramic, could be sealed with resin, wax or other suitable sealant to prevent or minimize leakage. In certain embodiments, the assembly 26 may be sterilizable to allow repeated use. In certain embodiments, the assembly may also be disposable so that it could be cheaply and easily manufactured. In other embodiments, the assembly may not be disposable but still made of such material that it can be cheaply manufactured. The assembly may be any suitable size and shape for sealing, or substantially sealing, the flow-through passageway. For example, in certain embodiments, the assembly may be between 0.1 inches and 4 inches, between 0.25 inches and 3 inches, between 0.5 inches and 4 inches in diameter and between half an inch and 6 inches, between 1 inch and 4 inches, or between 2 inches and 4 inches in length.

In certain embodiments, it is desirable to provide a means for containing the sediment, by-product, and/or other liquid to be separated from the system. In certain aspects this will be a reservoir. In certain aspects this will be a reservoir that further comprises a void space. The size and shape of the reservoir may vary depending on the needs of systems. The size and shape of the void space may vary depending on the needs of the system. In certain aspects the reservoir may be attached to the body by way of a length of tubing or a hose. This tubing or hose could be any size and shape suitable for the needs of the system. In other aspects, a reservoir may not be used but rather a by-pass or diverting system may be employed. In certain aspects a reservoir may be combined with a by-pass or diverting system to assistance in the removal of material and/or liquid from the system. In certain embodiments the same systems may be used to add material and/or liquids to the system. In certain aspects the same systems may be used to both add and remove material and/or liquids from the system. In certain embodiments, the void space may have whatever volume that is needed to accomplish the removal or addition of the materials and/or liquids. In some aspects, the void space volume will be between 0.1 ml and 50 ml, 0.1 ml and 25 ml, 0.1 ml and 10 ml, 0.25 ml and 50 ml, 0.25 and 10 ml, and 0.5 ml and 500 ml.

The reservoir 40 may be sealably mated to the distal end 18 of the body 14 in various ways. In certain embodiments illustrated in FIG. 1, the reservoir 40 may have an internal screw thread 44 at its open end portion 46 that is configured to threadably attach to an external screw thread portion 38 of the body 14. Seal members 48 and 50 provide a seal between the reservoir 42 and the body 14. When engaged, the screw threaded portion 22 may force the sealing member 24 into sealing engagement against the rim 108 of the container 100. Alternatively, any suitable means for attaching the distal end 18 to the reservoir 40 may be used such as a clamp, clip, bayonet, swivel fitting, or other fastener. In other embodiments, the distal end 18 and/or the open end of the reservoir 46 could consist of a plug, insert, or other suitable means of sealably mating body 14 with the reservoir 40. Additionally, the open end of the reservoir 40 could mate with the distal end 18 on the inside, the outside, or a combination of the inside and outside of the body 14.

In certain embodiments, the reservoir 40 further comprises a void space 42 and a stopper assembly actuator 52. The void space 42 may be any suitable shape and size suitable for containing the sediment, by-product, or other liquid. For example, in a bottle brewing application the void space 42 may be an annulus between 0.1 ml and 10 ml, 0.25 ml and 25 ml, 0.25 and 0.5 ml and 10 ml in volume. In other embodiments, the void space 42 may be a spherical hole or any other shape.

The stopper assembly actuator 52 causes the stopper assembly to open the flow-through passageway 20. For example, as shown in FIGS. 1 and 2, the stopper assembly actuator 52 may be an actuating pin. As illustrated, when the actuating pin 52 bears down against the upper end portion 39 of the valve body 34 as the reservoir 40 is screwed down onto the body 14, the pin 52 engages the valve body 34. In FIG. 1, the reservoir 40 has not been fully engaged (i.e. not screwed completely down) onto the body 14, thereby leaving a thread gap 54 and maintaining the stopper assembly 26 in the closed position. By comparison, in FIG. 2, the reservoir 40 has been fully engaged with the body 14. When the reservoir 40 is fully engaged, the valve member 34 is pressed against the bias of spring 36, causing the valve body 34 to lift off the valve seat 28, thereby opening the stopper assembly 26 and allowing flow from the orifice 108 into the void space 42 via the flow-through passageway 20. Advantageously, this embodiment automatically causes the stopper assembly 26 to open when the reservoir 40 is sufficiently engaged to the body 14. This may allow quick and easy operation of the apparatus to remove sediment and by-products. Moreover, in some embodiments when the reservoir 40 is disengaged, the stopper assembly 26 may be configured to shut.

In other embodiments, the stopper assembly actuator 52 could use a variety of mechanisms to cause the stopper assembly 26 to open when the reservoir 40 is sufficiently engaged to the body 14. The stopper assembly actuator 52 could mechanically actuate the stopper assembly using any suitable mechanical means, for example, a push-rod attached to a flapper valve. As another example, the reservoir 40 could magnetically actuate the stopper assembly 26 when brought into proximity with the body 14. The stopper assembly actuator 52 could alternatively activate a solenoid in the stopper assembly 26.

In certain embodiments, the reservoir 40 may be any suitable shape, for example it may be substantially conical as show in FIGS. 1 and 2. In alternative embodiments, the reservoir 40 could be cylindrical, square, triangular, oval or any other shape. The reservoir 40 could be segmented—composed of two or more pieces joined together either fixedly or removably. For example, the reservoir could be composed of two cylinders with different diameters configured one on top of the other. Advantageously, the reservoir 40 could be formed to provide a stable base for the apparatus. For example, in a bottle brewing application, the reservoir 40 could be wide and flat or could have legs to support an inverted bottle attached to the apparatus 10.

In certain embodiments, the reservoir may be constructed of any suitable material or combinations of materials. For example, the reservoir may be of a transparent, translucent or opaque polymeric material such as acrylic, epoxy resin, phenolic resin, fluoroplastic, nylon, rubber, plastic, polyvinylchloride, Terlux®, Xylex™, polystyrene (e.g., Styrofoam), a metal such as steel, iron or copper; a wood such as pine or oak; a mineral such as glass, silicon, or quartz; or a ceramic, porous materials could be sealed with resin, wax or other suitable sealant to prevent or minimize leakage, or combinations of the above. For example, in certain aspects, constructing the reservoir of transparent or translucent materials could advantageously enable visual inspection of the operation of the apparatus. In certain aspects, it may desirable to construct the reservoir such that it may also be disposable. In certain aspects, it may be desirable to construct the reservoir so that it could be cheaply and easily manufactured. The reservoir may be any suitable size and may be varied depending on the application. In certain aspects, between 0.5 inches and 4 inches in diameter and between 0.5 inches and 6 inches in length, 0.1 inches and 8 inches in diameter and between 0.1 inches and 10 inches in length, and between 1 inch and 3 inches in diameter and between 1 inch and 4 inches in length. Constructing the reservoir of transparent or translucent materials could advantageously enable visual inspection of the operation of the apparatus 10. Alternatively, the reservoir could be made of another material, for example, a metal such as steel, iron or copper; a wood such as pine or oak; a mineral such as glass, silicon, or quartz; or a ceramic. Porous materials could be sealed with resin, wax or other suitable sealant to prevent or minimize leakage. The reservoir 40 may be sterilizable to allow repeated use. The reservoir 40 may also be disposable so that it could be cheaply and easily manufactured. The reservoir 40 may be any suitable size, for example, typically between half an inch and 4 inches in diameter and between half an inch and 6 inches in length.

In one embodiment, the disclosure may be used to remove sediment from a bottle brewed beer. As illustrated in FIG. 1, the reservoir 40 is first partially engaged, thereby leaving the stopper assembly 26 in the closed position. Then the apparatus 10 and the bottle 100 may be inverted to the position as illustrated in FIG. 2. As previously described, the reservoir 40 may have a relatively broad flat surface for the bottle 100 to rest in the inverted position. The reservoir 40 may then be fully engaged, thereby causing the stopper assembly 26 to open and liquid to flow from the bottle, through the flow-through passageway 20 and into the void space 42 of the reservoir 40.

Due to gravity, sediment 110 is normally deposited in the bottom of a bottle 100 when in the upright position. However, when the bottle 100 is inverted the sediment 110 will make its way through the neck 112 and opening 114 of the bottle 100, through passageway 20, and into the void space 42. One advantage of this disclosure is that the secondary fermentation of the beer may be performed with the bottle 100 inverted and the stopper assembly 26 maintained in the open position. This configuration may allow the sediment to automatically accumulate in the void space during fermentation. Another advantage is that the reservoir 40 may be removed while the bottle is still inverted, thereby automatically closing the stopper assembly 26 and keeping the bottle 100 sealed.

In some embodiments, the apparatus may be at least partially transparent. This may allow the user to visually determine when the sediment has been sufficiently removed and to then re-seal the bottle 100. When the bottle is re-sealed, a small amount of liquid from the bottle 100 may be trapped in the void space 42 and the space surrounding the valve member 30 from the seal member 32 outward.

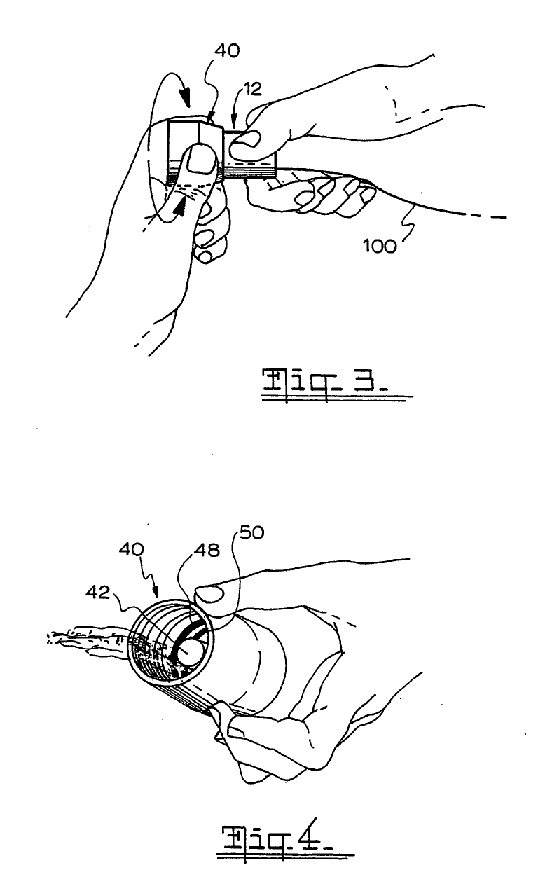

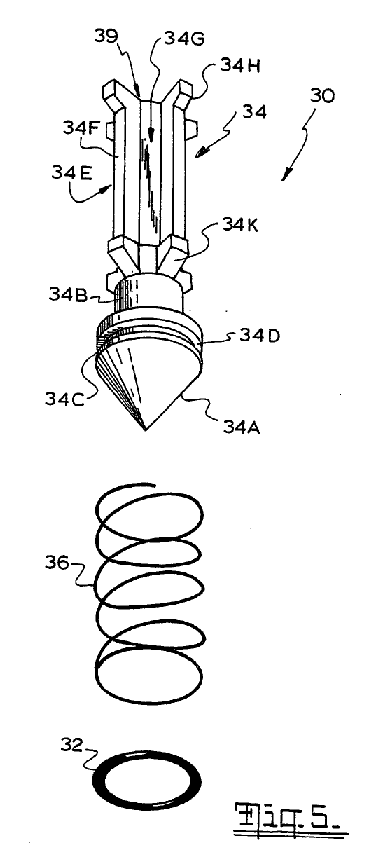

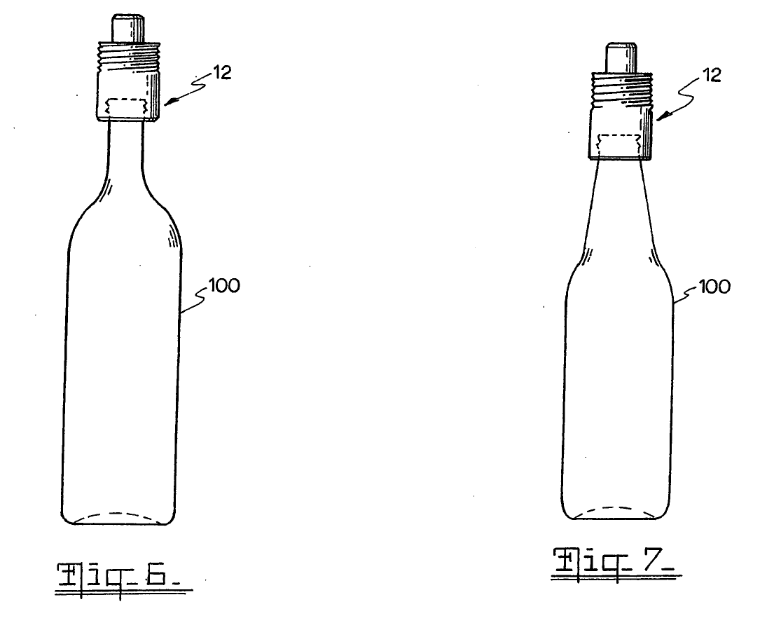

Exemplary embodiments shown in FIGS. 3 and 4 illustrate removal of the actuator 25 and its cleaning in FIG. 4. An exemplary embodiment of the valve member 30 is illustrated in greater detail in FIG. 5 and FIGS. 6 and 7 illustrate application of the seal 12 to wine and beer bottles respectively.

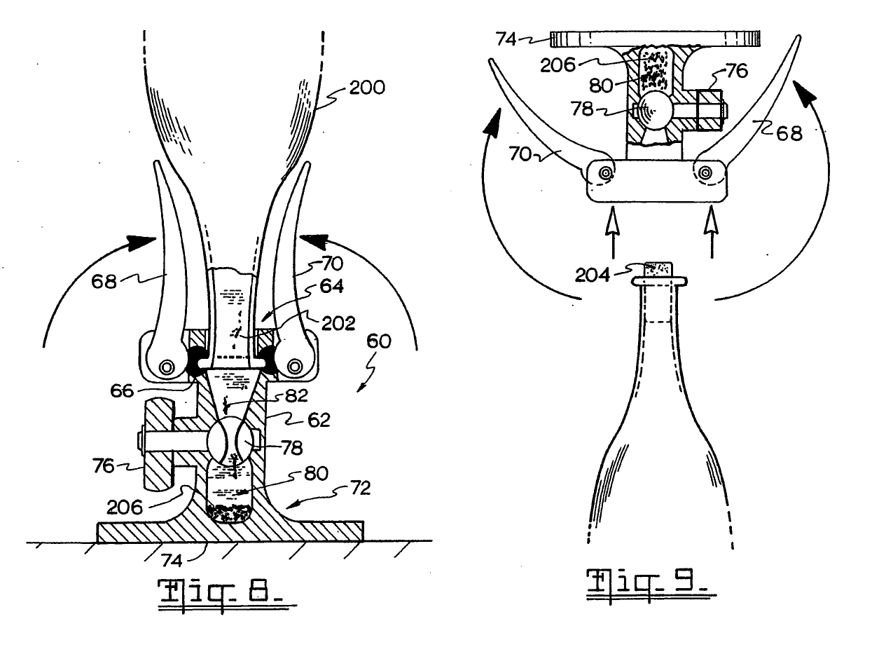

Referring to the exemplary embodiment illustrated in FIG. 5, the valve member 30 as shown may have its valve body 34 formed with an enlarged and substantially conical shaped valve head 34A extending from a neck portion 34B. The valve head 34A may have a cylindrical portion 34C adjacent to the neck portion 34B. The cylindrical portion 34C may be formed with a periphery groove 34D adapted to receive and retain thereat the sealing ring 32. The sealing ring 32 may engage the valve seat 28 when the valve member 30 is in the closed position as shown in FIG. 1 and may be moved away from the valve seat 28 when the valve member is in the open position so that the passageway 20 is open for the sediment 110 to flow into the reservoir 42 as shown in FIG. 2. A tail portion 34E may be joined to the neck portion 34B. The tail portion 34E may have spaced radically extending elements 34F adapted to form longitudinal flow passages 34G between adjacent elements 34F. Each of the elements 34F may have extended end parts 34H and 34K forming a recessed space for receiving the spring 36. In certain embodiments, it may be desirable to have a system that may be used in conjunction with liquids where there is a tendency for material that you want to have removed accumulates over time. Certain aspects of such a system are illustrated in FIGS. 8 and 9.

Referring now to FIGS. 8 and 9 there is illustrated an exemplary alternative embodiment that may be used in conjunction with, for example, red wines where there is a tendency for accumulation of sediment in wine as it ages. In FIG. 8 there is shown a container 200 and an apparatus 10 for extracting substances from a liquid having a body member 62 with an open end portion 64 arranged to seal an opening 202 to the container 200. The apparatus 60 includes a sealing ring 66 at the end portion 64 wherein the ring 66 may be applied to the opening 43 by respective clamping arms 68 and 70 prior to the container 200 along with assembly 60 being inverted into the inverted position of FIG. 8. The apparatus 60 may have a closed end 72 with a relatively large flat external surface 74 so that the container 200 will remain supported in the inverted position by the apparatus 60. It will be appreciated that the cork 204 may be removed from the bottle 200 before the apparatus 60 is inserted. In alternative embodiments, the apparatus may provide a mechanism for installation through the cork 204. For example, the mechanism may be a tube with a punch at the end. Upon inversion, a valve actuator 76 may be manually turned to operate a valve member 78 to move to the open position and a small amount of wine may then be discharged from the container 200 into that part of the apparatus downstream whilst on the seal member 62. Sediment 206 may then flow into the reservoir 80 as depicted in FIG. 8. Once the desired amount of sediment 206 from the container 200 is in the chamber 80, the valve 78 may be moved to the closed position by turning the actuator 76. The container 200 can then be returned to the upright position illustrated in FIG. 9 and that portion of liquid at 82 flows back into the bottle. The apparatus 60 may be removed from the container 200 and the container may then be re-corked as illustrated in FIG. 9.

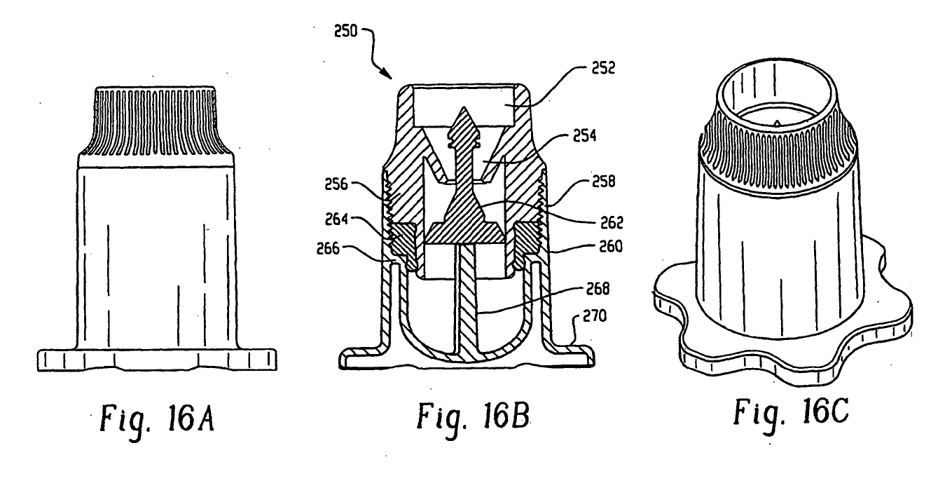

FIGS. 16A-C, 17, 18A-B, 19A-F, 20A-D, 21A-D, 22A-B, 23, 24A-E, and 25 illustrate an exemplary embodiment of the disclosure for extracting sediment from a bottled beer. FIG. 16A illustrates a side view of the fully assembled apparatus assembly according to this embodiment. Referring to FIG. 16B, the apparatus comprises a body 250 with an open cylindrical top portion 252 adapted to sealably couple to the top of a bottle (not shown). The body 250 also has a flow through passageway 254 and an external threaded portion 256 adapted to threadably couple to an internal threaded portion 258 of a reservoir 260. The flow through passageway 254 contains a valve assembly 262 configured to seal the flow through passageway 254 responsive to a biasing element. The reservoir 260 has a base 270 formed in the bottom portion adapted to support the weight an inverted beer bottle attached to the assembly.

Several aspects of this embodiment prevent and/or minimize leakage. The biasing element may be a spring (not shown) as described above that maintains the valve assembly 262 in a normally shut position. Alternatively, the valve assembly 262 could be maintained in the normally shut position by the force of gravity pushing the valve assembly. In this alternative aspect, when the body 250 is attached to a bottle containing a liquid and the body is maintained in an inverted position, the force of the liquid will provide additional pressure on the valve assembly 262, thereby maintaining a tight seal. Additionally, a sealing ring 264 is adapted to fit between the lower portion of the body 250 and an inner lip portion 266 of the reservoir 260 to thereby minimize leakage. The reservoir 260 contains a valve actuating shaft 268 configured to push the valve assembly 262 to an open position when the reservoir 260 is threaded onto the body 250.

The components of this embodiment (i.e., the body 250, reservoir 260, valve assembly 262, and sealing ring 264) are preferably constructed from a thermoplastic such as Terlux®, or Xylex™. Also, the materials could be substantially transparent or translucent to enable a user to observe the operation of the assembly. The assembly could be of a suitable size for attaching to the mouth of a beer bottle.

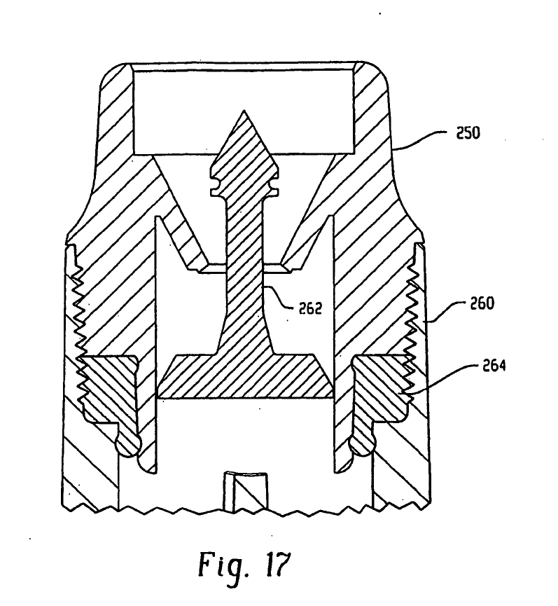

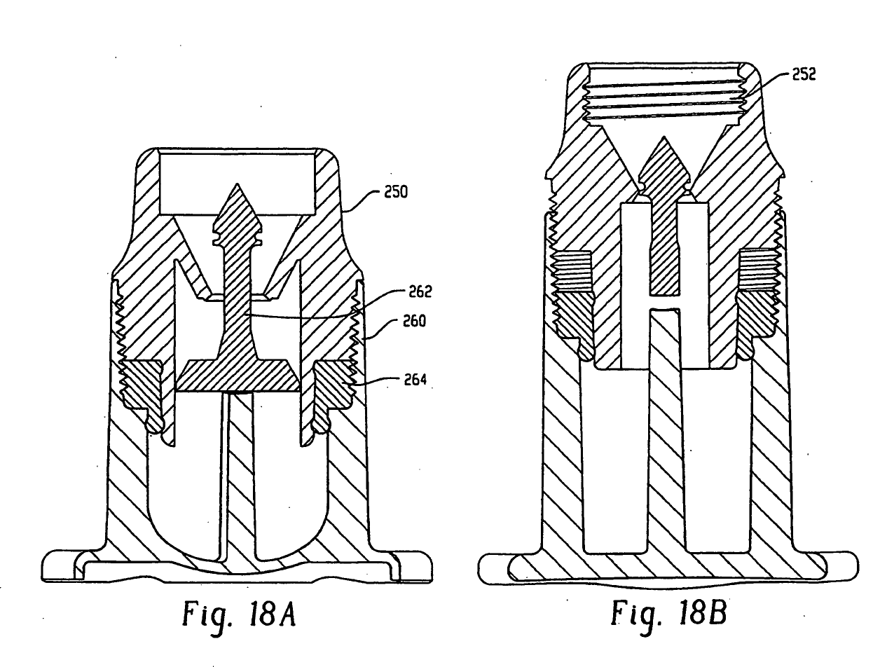

FIG. 16C illustrates an isometric top view of the entire assembly. FIGS. 17 and 18A illustrate a cutaway blow-up view of the body 250, reservoir 260, valve assembly 262, and sealing ring 264 in an assembled configuration. Referring to FIG. 18B, the open cylindrical top portion 252 may have an internal threaded portion adapted to screw onto the external threaded portion of a beer bottle (not shown). FIG. 18B also illustrates the valve assembly 262 in its normally shut position.

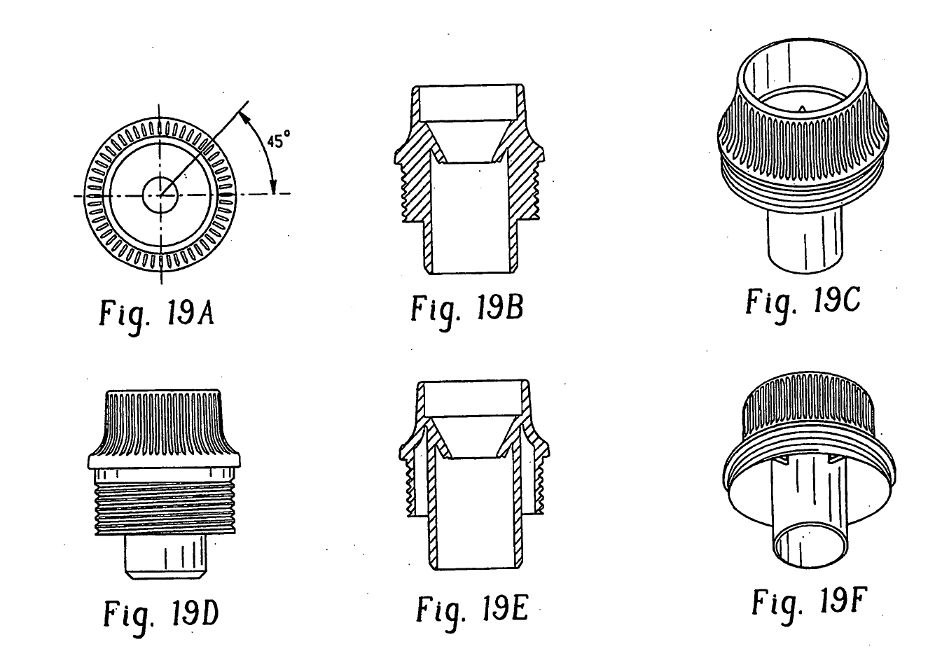

FIGS. 19A to 19F illustrate various views of the body 250 of the assembly. FIG. 19A shows a top view of the body 250. FIGS. 19B and 19E show a cutaway side view of the body 250. FIG. 19C shows an isometric top view of the body 250. FIG. 19D shows a side view of the body 250. FIG. 19F shows an isometric bottom view of the body 250.

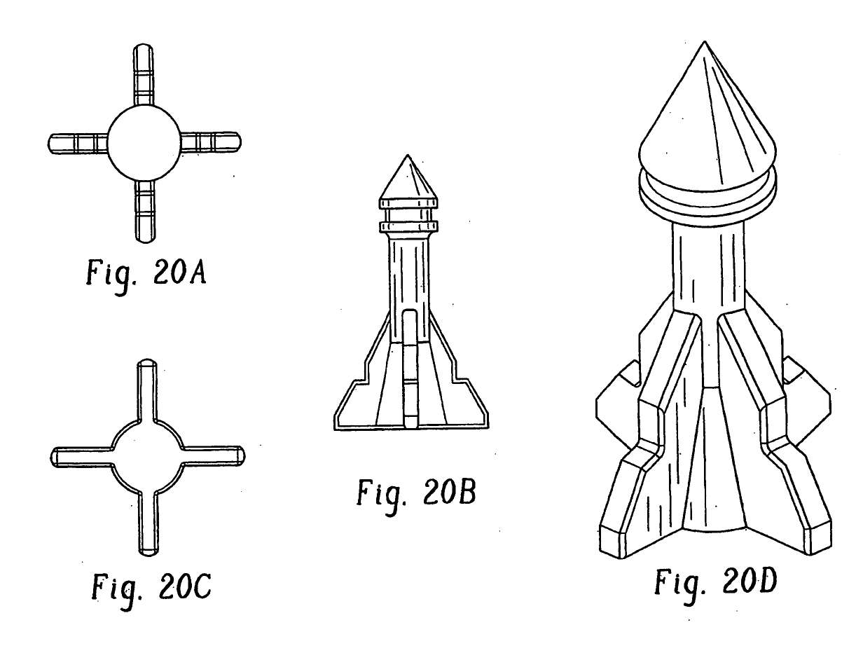

FIGS. 20A to 20D illustrate various views of the valve assembly 262. FIG. 20A shows a top view of the valve assembly 262. FIG. 20B shows a side view of the valve assembly 262. FIG. 20C shows a bottom view of the valve assembly 262. FIG. 20D shows an isometric top view of the valve assembly 262.

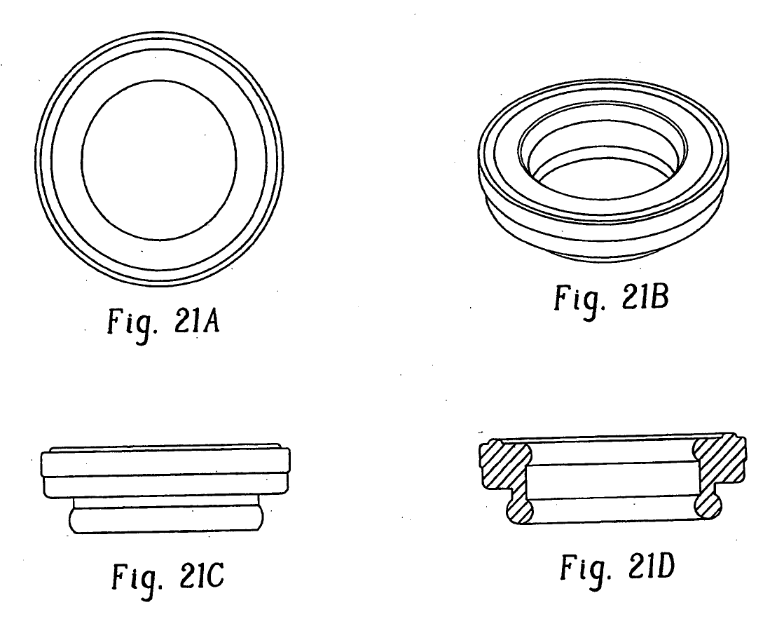

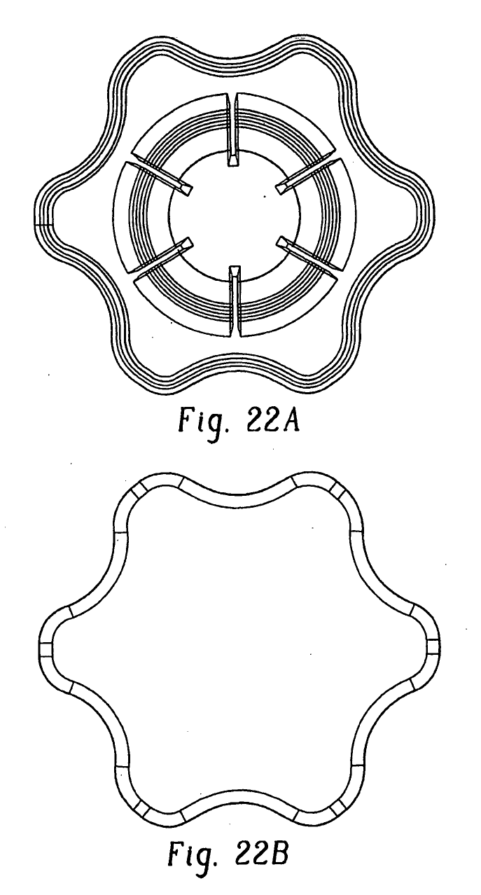

FIGS. 21A to 21D illustrate various views of a sealing ring 264. FIG. 21A shows a top view of the sealing ring 264. FIG. 21B shows an isometric top view of the sealing ring 264. FIG. 21C shows a side view of the sealing ring 264. FIG. 21D shows an isometric side view of the sealing ring 264.

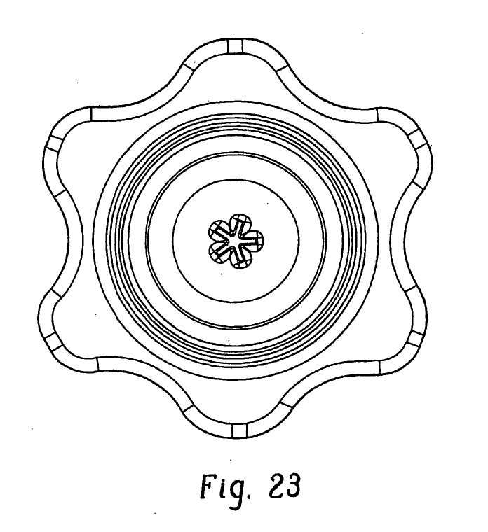

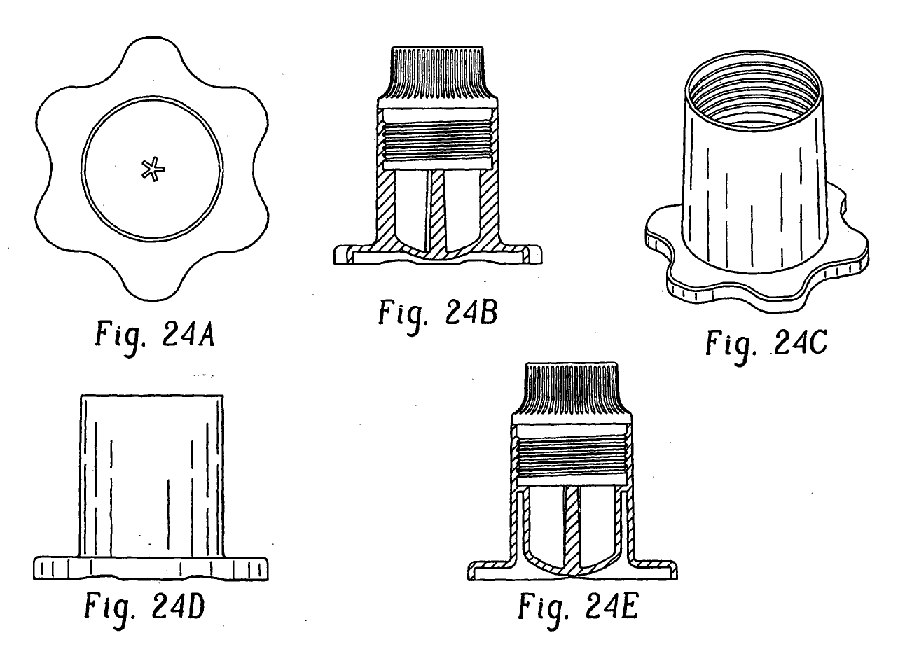

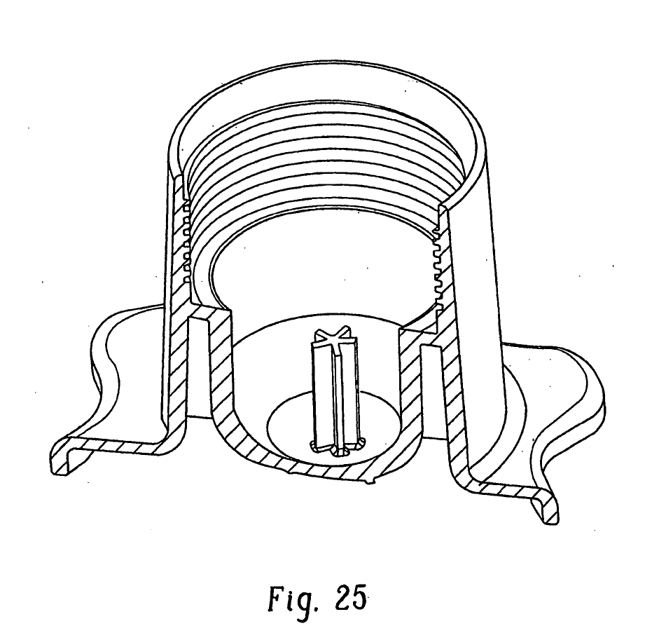

FIGS. 22A-B, 23, 24A-E, and 25 illustrate various views of the reservoir 260. FIGS. 22A and 22B show a bottom view of two alternative designs of the reservoir 260. FIG. 23 illustrates a blown-up top view of the reservoir 260. FIG. 24A shows a top view of the reservoir 260. FIG. 24B shows a cutaway side view of the reservoir 260. FIG. 24C shows an isometric top view of the reservoir 260. FIG. 24D shows a side view of the reservoir 260. FIG. 24E shows another cutaway side view of the reservoir 260. FIG. 25 shows an isometric top cutaway view of the reservoir 260.

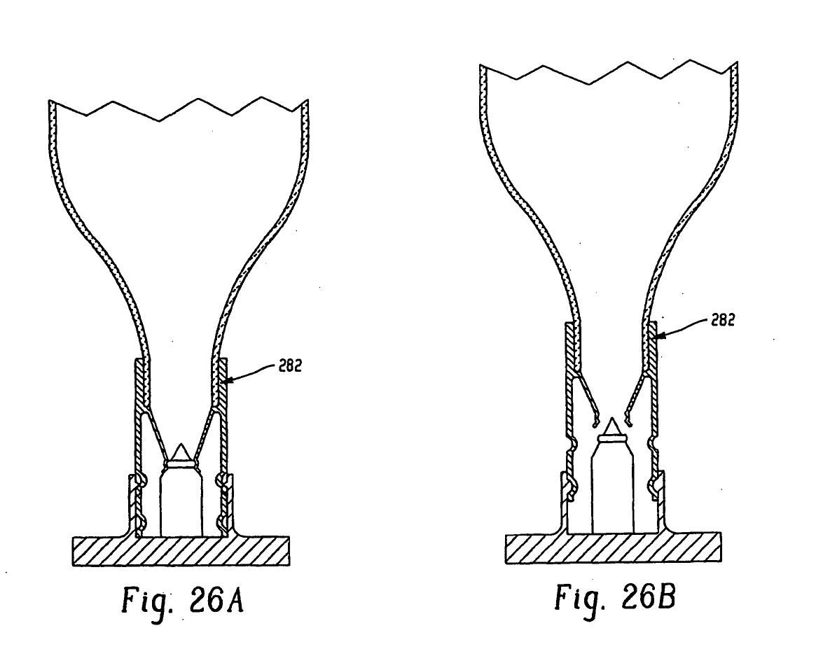

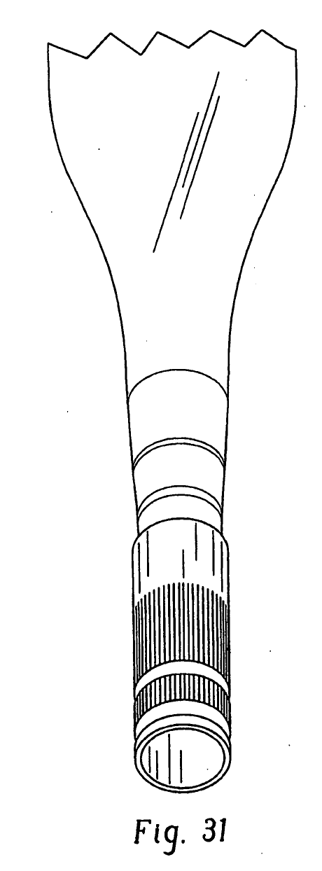

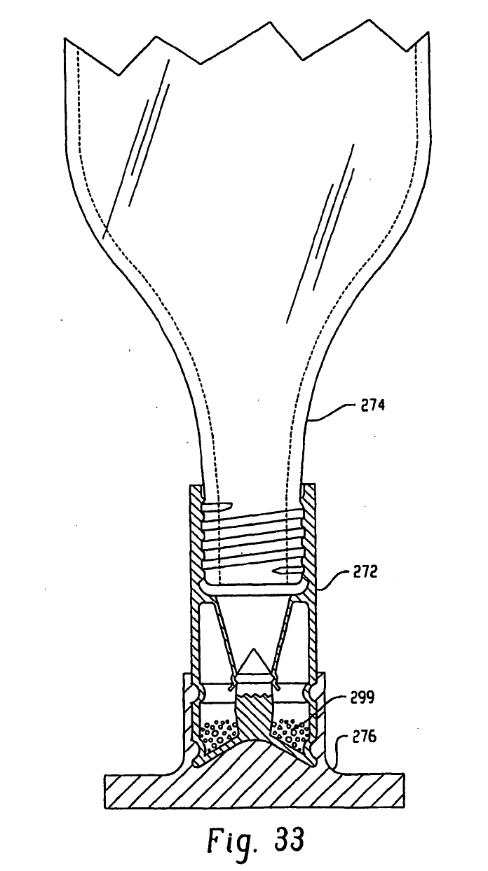

FIGS. 26A, 26B, 27, 28, 29, 30, 31, 32, 33, and 34A to F illustrate certain embodiments of the disclosure for extracting sediment from a bottle of wine or a container. In certain aspects, this apparatus may be used with other containers where there is a desire to separate substances, fluids, sediments, or combinations thereof from the liquid in the container.

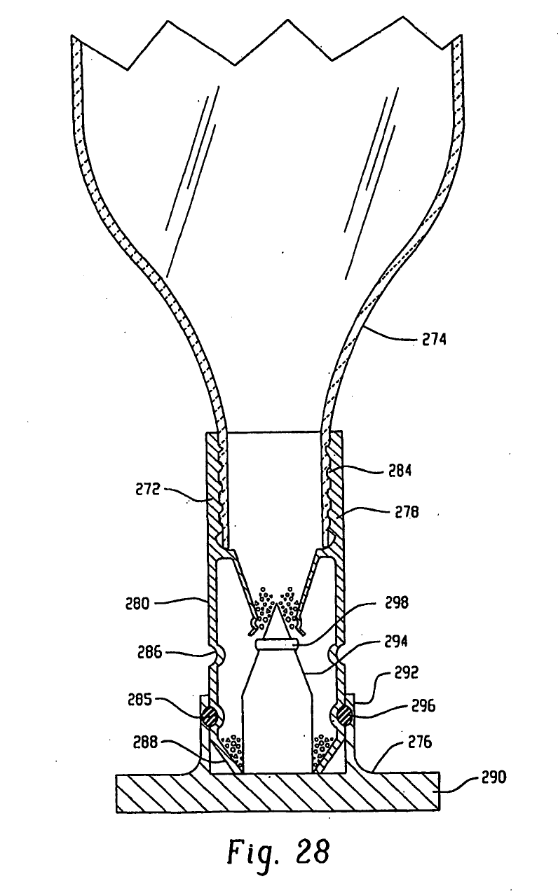

FIG. 28 illustrates a side view of the fully assembled apparatus assembly according to certain embodiments. Referring to FIG. 28, the apparatus is composed of a bottle cap assembly 272 sealably attached to the mouth of a bottle 274 and a base 276.

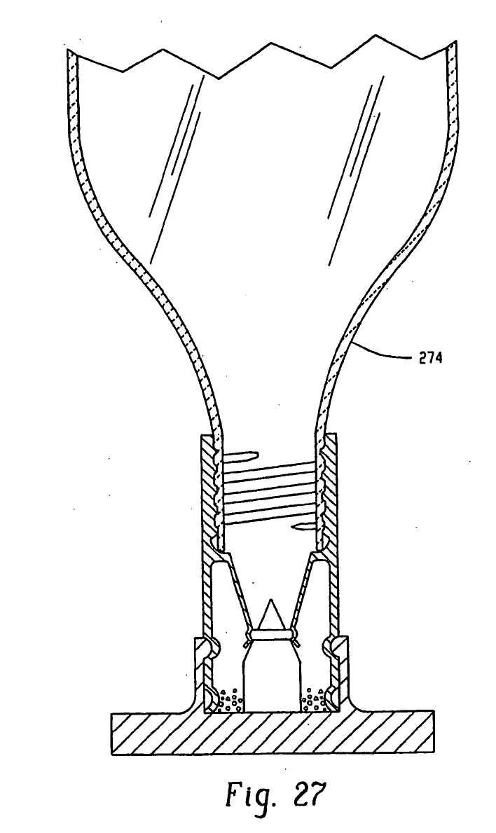

As shown, the bottle cap assembly 272 comprises a capping member 278 and a cylindrical skirt 280. The capping member 278 may be substantially funnel shaped, having a wide opening at the top end and a narrower opening at the bottom end. The top end of the capping member may be a pressure-fitted plug assembly 282 attached tightly to the inside of the bottle mouth as shown in FIGS. 26A and 26B, or it may be an internally threaded portion 284 adapted to threadably attach to the external threaded portion of the wine bottle 274 as shown in FIG. 27. The cylindrical skirt 280 extends downward from the edges of the capping member 278 to the base 276. The cylindrical skirt 280 of the bottle cap assembly 272 may contain bottom 285 and top 286 indented grooves running around its circumference. In certain embodiments, as shown in FIGS. 28 and 30 to 34F, some portion of the skirt 288 below the second notch may be made of collapsible plastic that may be in contact with the base 276. In certain embodiments, there may be a gap between the bottom of the skirt 288 and the base 276 as shown in FIG. 26A.

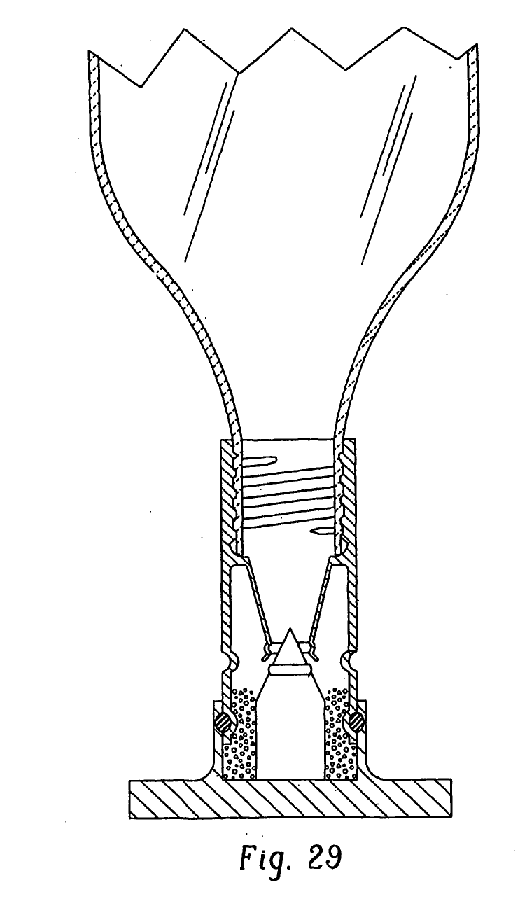

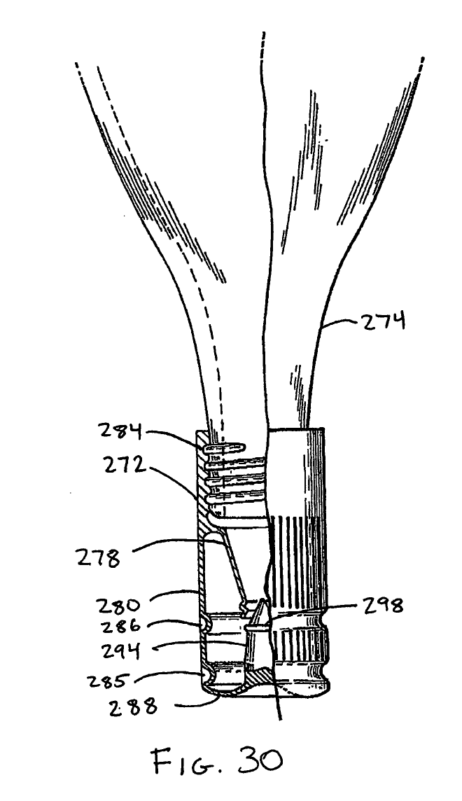

The base 276 consists of a broad flat bottom portion 290 suitable for supporting the weight of the wine bottle 274 in the inverted position, and an open cylindrical top portion 292 adapted to fit tightly within the skirt 288 of the bottle cap assembly 272. In some embodiments, as shown in FIGS. 26A and 29, the base may contain a shaft 294 adapted to fit tightly within the bottom end of the capping member 278. In other embodiments, as shown in FIGS. 28 and 30 to 34F, the shaft 294 may be attached within a bottom portion of the skirt 288. In certain aspects, the shape of the base may be varied. The cylindrical top portion 292 has a raised notch or o-ring 296 running around its circumference. To prevent and/or minimize leakage, the grooves 285, 286 of the skirt 288 are configured so that each may fit tightly within the raised notch or o-ring 296 of the top portion 292. As shown in FIGS. 26A and 30, the shaft 294 may be cylindrical at the bottom and conical at the top. The conical end of the shaft may have an o-ring or raised notch 298 running around its circumference.

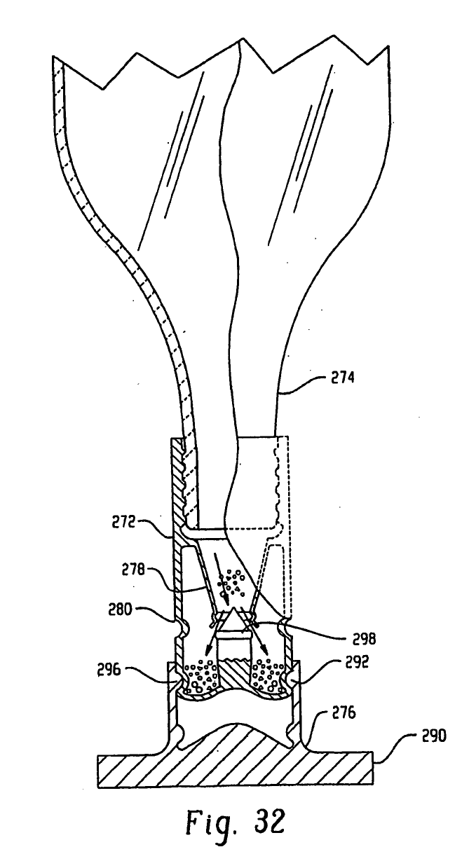

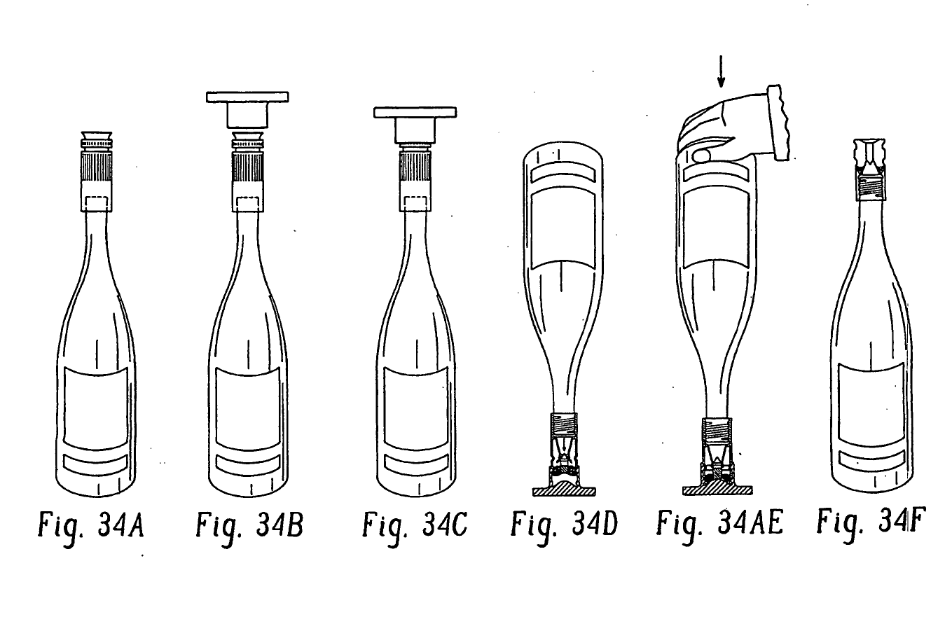

In an exemplary operation, illustrated in FIGS. 30, 31, and 34A, the capping member 278 of the bottle cap assembly 272 is attached to the mouth of a wine bottle 274. The raised notch or o-ring 296 on the base is then mated with the lower groove 285 on the skirt 288 of the bottle cap assembly 272 as shown in FIGS. 32, 34B, and 34C. As illustrated in FIG. 34D, the wine bottle, or container, 274 can then be inverted and supported by the bottom portion 290 of the base 276. Wine from the bottle 274 may then flow into the bottle cap assembly 272 and base 276. FIGS. 26A, 28, 29, 30, 31, 32, and 34D illustrate the apparatus in this configuration, i.e., the open position with wine able to flow freely into the apparatus.

Once a desired amount of sediment (substances, fluids, sediments, or combinations thereof) has settled into the apparatus the sediment 299 may be locked out of the bottle or container as shown in FIG. 34E. This is done by pressing the bottle 274 down, thereby forcing the skirt 288 down into the base 276 such that the upper groove 286 on the skirt 288 snaps onto the raised notch or o-ring 296 on the base 276. In this configuration, the narrow opening at the bottom end of the capping member 278 is sealed by the shaft 294. FIGS. 26B, 27, 33 and 34F illustrate the apparatus in this configuration, i.e. the closed position with the bottle, or container, sealed to prevent and/or minimize leakage from the bottle. At this point the entire base 276 may be detached leaving the shaft 294 and the top portion 292 as shown in FIG. 34F. Alternatively, some portion of the base such as the bottom portion 290 may be detached. Advantageously, this operation allows the sediment 299 to be locked out of the bottle and seals the bottle 274 for transport or storage, whilst also allowing removal of an unwieldy portion of, or the entire base 276.

The components of this exemplary embodiment (i.e., the bottle cap assembly 272 and the base 276) are preferably constructed from a thermoplastic such as Terlux®, or Xylex™. In certain embodiments the apparatus may be disposable. Also, the materials could be substantially transparent or translucent to enable a user to observe the operation of the assembly. The assembly could be of a suitable size for attaching to the mouth of a wine bottle.

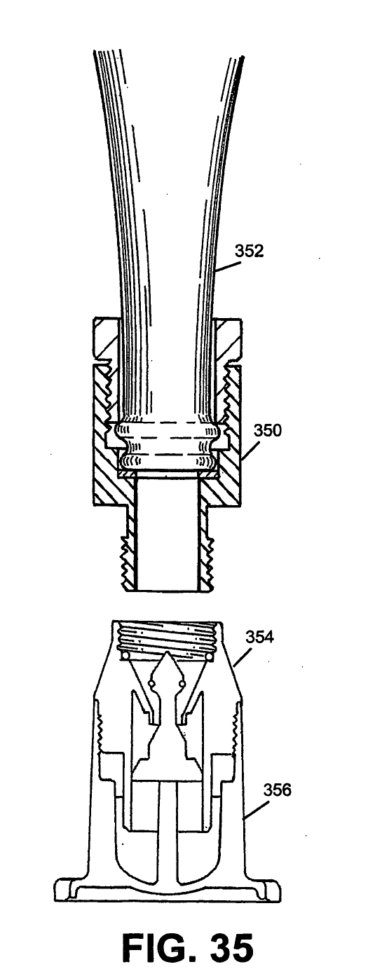

FIGS. 35, 36A to 36D, 37, and 38 illustrate another exemplary embodiment of the present disclosure for extracting sediment from a bottle or container. While this embodiment may be suitable for a variety of bottles, it may be particularly desirable for sparkling wine bottles. In certain aspects, this apparatus may be used with other containers where there is a desire to separate substances, fluids, sediments, or combinations thereof from the liquid in the container.

FIG. 35 illustrates a side view of the fully assembled apparatus assembly according to the exemplary embodiment. Referring to FIG. 35, the apparatus is composed of a bottle cap assembly 350 sealably attached to the mouth of a sparkling wine bottle 352, and a body 354 threadably attached into a reservoir 356. Advantageously, the bottle cap assembly 350 described in the exemplary embodiment may provide a tight seal with the mouth of the sparkling wine bottle 352. The body 354 and reservoir 356 may be similar to the body and reservoir previously described in connection with, for example, FIG. 17.

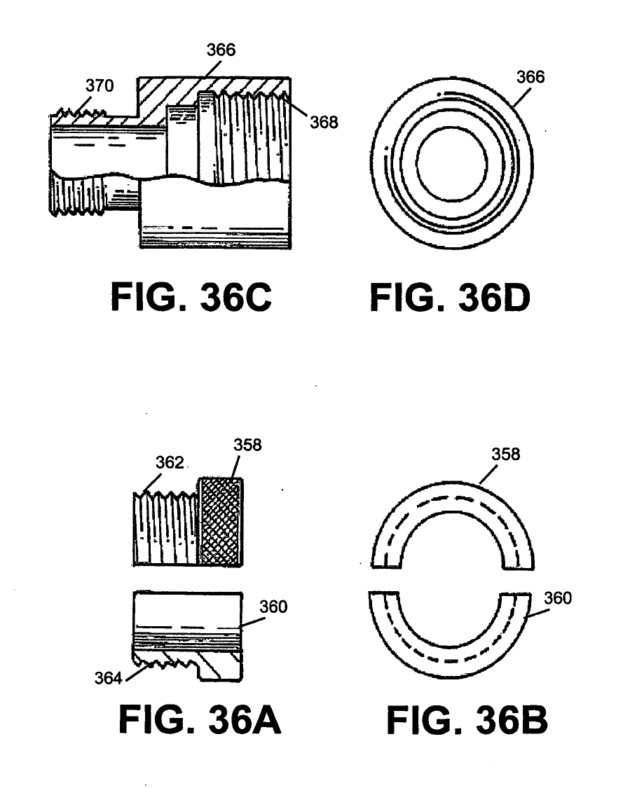

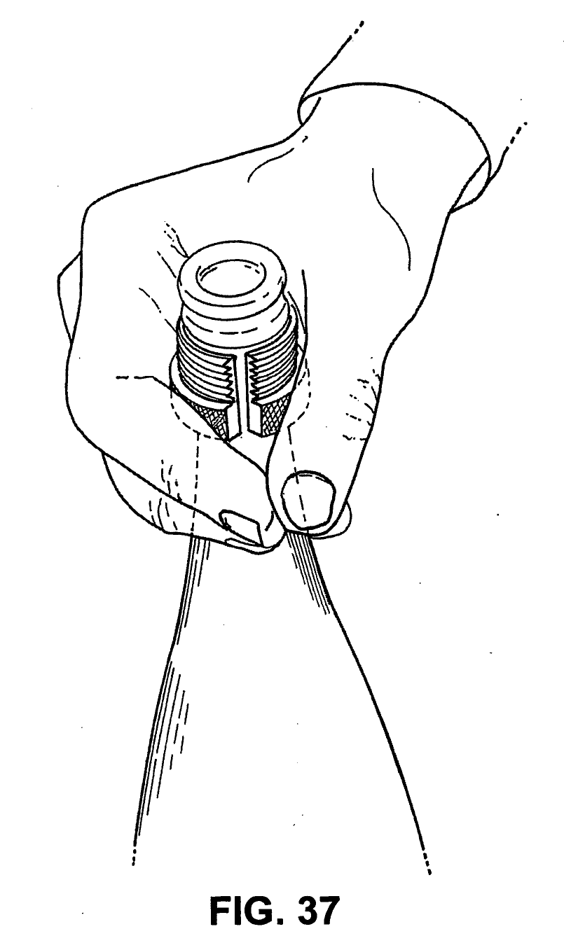

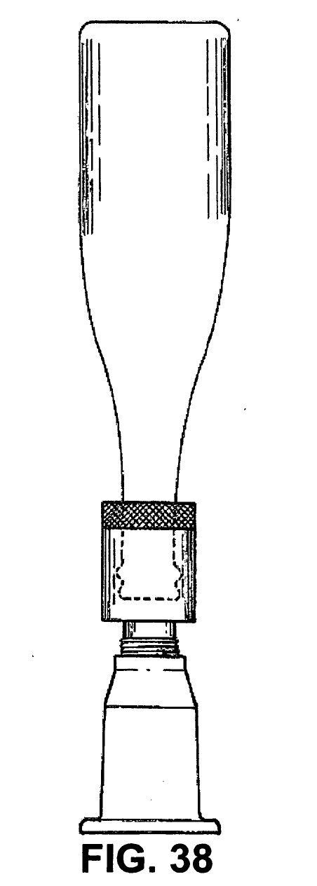

In the exemplary embodiment as illustrated in FIGS. 36A to 36D, the bottle cap assembly 350 is composed of three pieces. FIG. 36A shows a cutaway side view of both halves of a bifurcated annular skirt 358, 360, which are two pieces of the bottle cap assembly 350. FIG. 36B shows a top view of these pieces 358, 360. Both halves of the bifurcated annular skirt 358, 360 can be attached to the mouth of a bottle as illustrated in FIG. 37. Each half 358, 360 includes a threaded portion 362, 364 formed thereon. FIG. 36C shows a cutaway side view of the third piece of the bottle cap assembly 350, which is an annular sealing member 366. FIG. 361) shows a top view of this piece 366. This piece contains an internal threaded portion 368 that is adapted to threadably attach to the threaded portions 362, 364 of the annular skirt pieces 358, 360. Threadably attaching the annular sealing member 366 to the annular skirt pieces 358, 360 seals the bottle cap assembly 350 onto the mouth of the bottle 352 as illustrated in FIG. 35. The annular sealing member 366 also includes a threaded portion 370 formed thereon that is adapted to threadably attach to an internal threaded portion of the body 354. FIG. 38 illustrates this exemplary embodiment in a fully assembled configuration with the bottle cap assembly 350 sealed on the mouth of the bottle 352, the body 354 threadably attached to the bottle assembly 350, and the reservoir 356 threadably attached to the body 354.

In operation, the exemplary embodiment performs similarly to the previously discussed embodiments, i.e., the bottle cap assembly 350 is attached to the sparkling wine bottle and then threaded onto the body 354. The body 354 can then be threaded onto the reservoir 356, which causes a flow path to be opened from the bottle 352 into the reservoir 356. The bottle 352 can then be inverted and supported by a base formed on the reservoir 356 until a desired amount of sediment has settled into the base. The reservoir 356 can then be unthreaded from the body 354, thereby sealing the sediment within the reservoir.

The components of this exemplary embodiment (e.g., the bottle cap assembly 350, base 354, and reservoir 356) are preferably constructed from a thermoplastic such as Terlux®, or Xylex™. In certain embodiments the apparatus may be disposable. Also, the materials could be substantially transparent or translucent to enable a user to observe the operation of the assembly. The assembly could be of a suitable size for attaching to the mouth of a sparkling wine bottle.

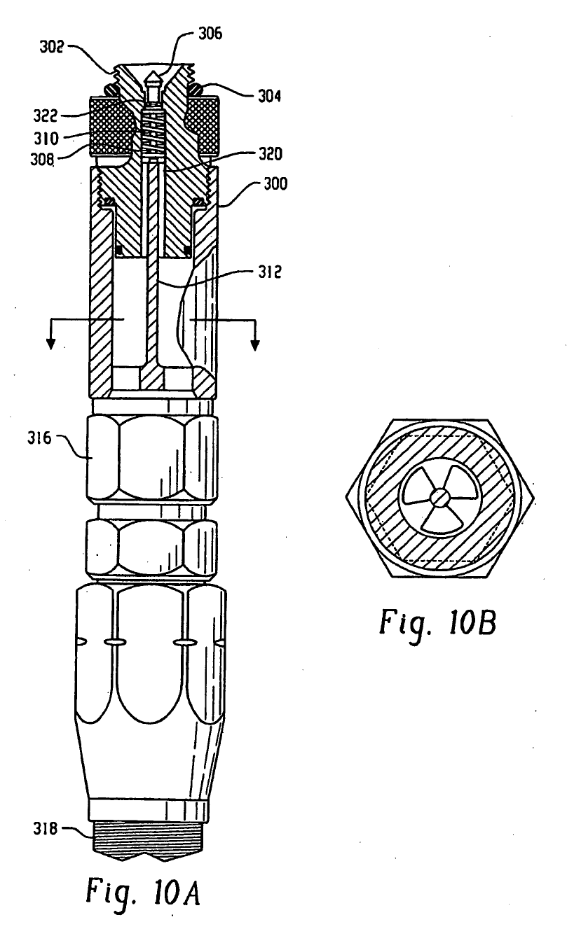

In another embodiment the disclosure could be used to convey fluids such as fuel or oil. For example, as illustrated in FIG. 10, the disclosure may be used as a detachable assembly connecting a first fuel tank to a second fuel tank (e.g., connecting a fuel settling tank to a fuel storage tank) or a safety valve for hose lines.

As shown in FIG. 10A, the detachable assembly or safety valve comprises a cylindrical body 300 having a screw thread 302 in the top portion, a swivel fitting 314 in the bottom portion (a bottom view of the swivel fitting 314 is illustrated in FIG. 10B), and a flow through passageway 320 between the top portion and the bottom portion configured to convey fuel or oil through the body 300. The screw thread 302 may be an internal screw threaded portion that is configured to threadably attach to an external screw thread portion of a line, hose, or tank fitting. The screw thread 302 may also be configured with an o-ring 304 to provide a tight seal between the body 300 and the line, hose or tank fitting. The flow through passageway 320 contains a valve head 306 and valve stem 308 that are biased to remain shut against the valve seat 322 by the force of a spring 310. The bottom portion of the body also contains a valve actuator 312 in contact with the valve stem 310. The valve actuator 312 is configured so that when the swivel fitting 314 is mated with a complementary line fitting 316, the valve stem 308 and valve head 306 are pushed to an open position against the spring pressure.

In an exemplary operation, the detachable assembly may be installed on a fitting of a fuel storage tank. Advantageously, in its normally shut position the assembly will prevent and/or minimize leakage from the tank because the spring pressure will keep the valve head 306 sealed tightly against the valve seat 322. When the fuel in the tank needs to be transferred, a line 318 with a suitable line fitting 316 may be mated with the swivel fitting 314 of the assembly and the valve head 306 will be forced to an open position, thereby allowing flow through the assembly. When the desired amount of fuel has been transferred, the line fitting 316 may be easily detached from the swivel fitting 314, thereby stopping flow. Once again, this assembly provides the advantage that little or no fuel will be spilled when the line 318 is attached and disconnected.

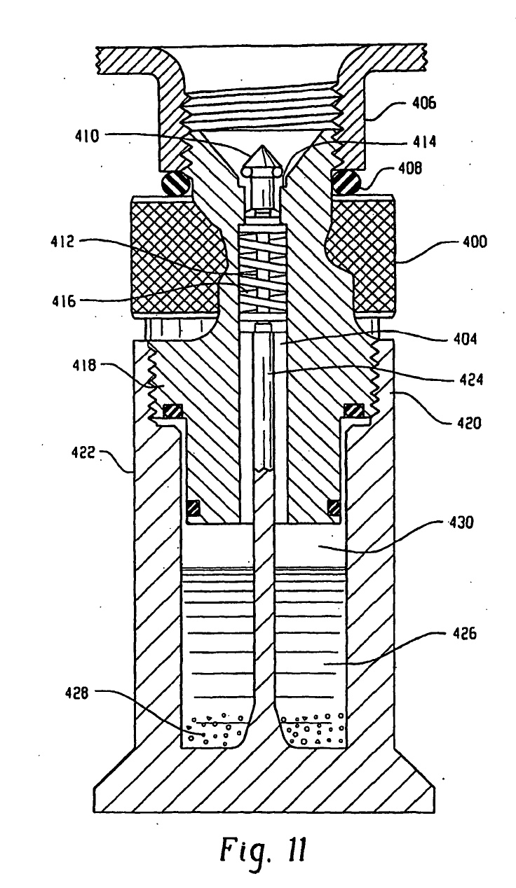

In still another embodiment, the disclosure could be used as a sediment pot or separating tank for a storage tank used for storing a hydrocarbon liquid such as fuel or oil. For example, as illustrated in FIGS. 11, 12, 13, 14, 15A and 15B the disclosure may be used as a detachable assembly for removing water and sediment (e.g., sand, dirt and grit) from a fuel tank while minimizing and/or preventing leakage of fuel.

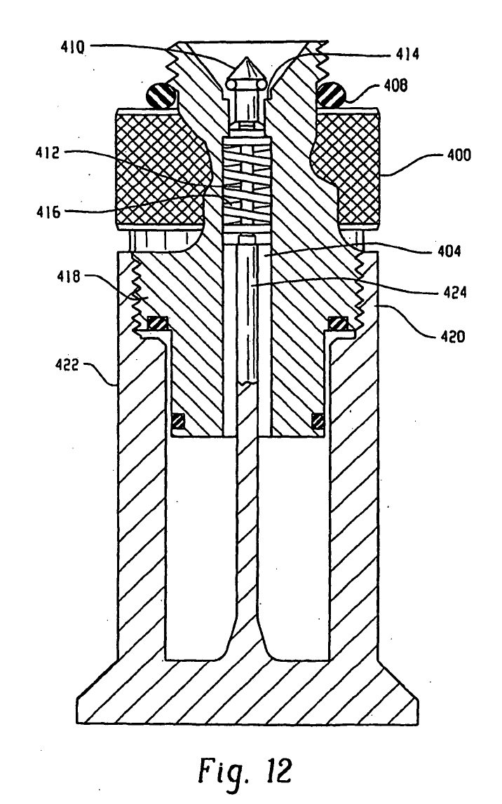

As shown in FIGS. 11 and 12, the detachable assembly comprises a cylindrical body 400 having a screw thread 402 in the top portion and a flow through passageway 404 between the top portion and the bottom portion of the body 400. The screw thread 402 may be an internal screw threaded portion that is configured to threadably attach to an external screw thread portion of the tank opening 406. FIG. 11 illustrates the assembly attached to a fuel tank and FIG. 12 illustrates the assembly disconnected from a fuel tank. The screw thread 402 may also be configured with an o-ring 408 to provide a tight seal between the body 400 and the tank opening 406. The flow through passageway 404 contains a valve head 410 and valve stem 412 that are biased to remain shut against the valve seat 414 by the force of a spring 416.

The bottom portion of the body has an external threaded portion 418 formed therein suitable to threadably attach to an internal threaded portion 420 of a cylindrical reservoir 422. The reservoir 422 contains a valve actuator (e.g., a shaft or plunger) 424 adapted to contact with the valve stem 412. The valve actuator 412 is configured so that when the reservoir 422 is threadably attached to the bottom portion of the body 400, the valve stem 412 and valve head 410 are pushed to an open position against the spring pressure.

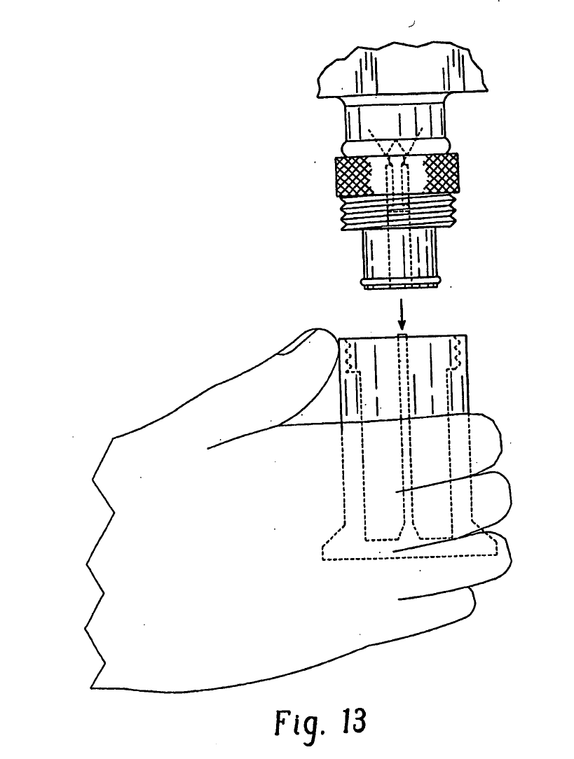

In an exemplary operation, the body 400 of the detachable assembly may be installed on a fitting at a low point of a fuel storage tank. Advantageously, in its normally shut position the assembly will prevent and/or minimize leakage from the tank because the spring pressure will keep the valve head 410 sealed tightly against the valve seat 414. The reservoir 422 can then be threadably attached to the body 400. As described above, when the reservoir 422 is attached, the valve head 410 moves to an open position, thereby allowing flow. Due to gravity, liquid water 426 and sediment 428 will be deposited in the bottom of the reservoir 422, thus settling below a layer of fuel 430. Periodically, the reservoir 422 can be removed and emptied to extract water and sediment. When the reservoir 422 needs to be removed, the reservoir 422 may be easily disconnected from the body 400 as shown in FIG. 13, thereby sealing the body. Once again, this assembly provides the advantage that little or no fuel will be spilled when the reservoir 422 disconnected.

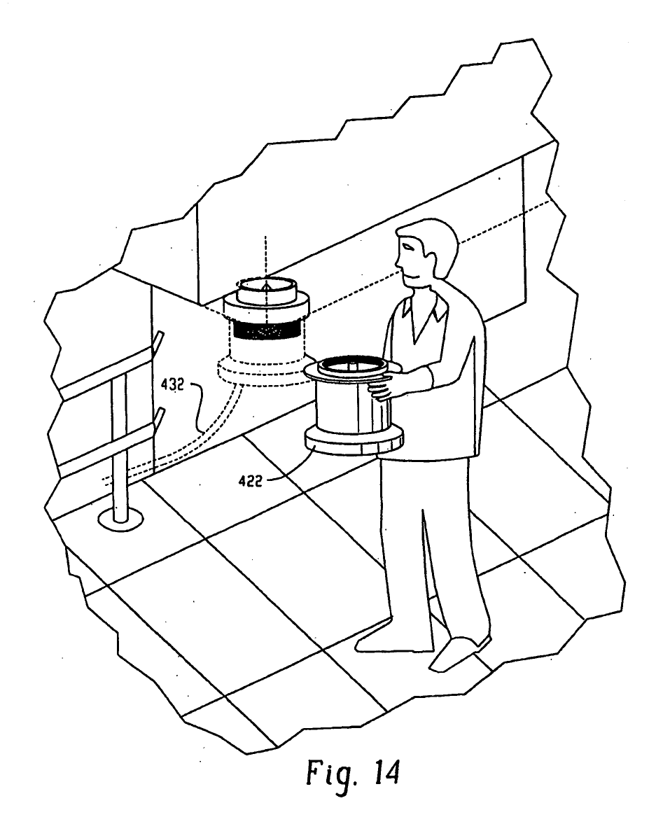

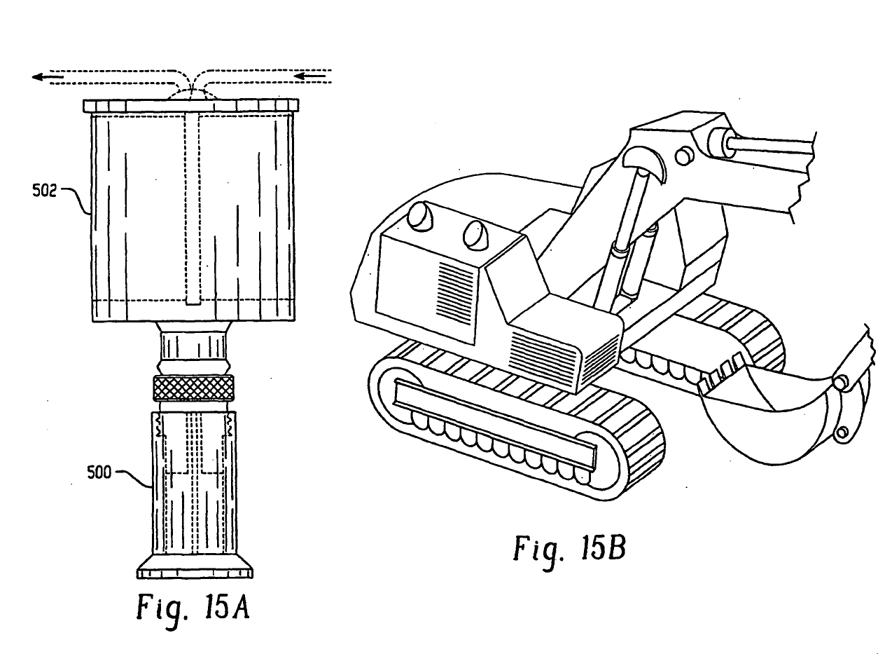

This embodiment could be useful in a variety of applications. For example, as shown in FIG. 14, it could be used in stationary fuel tank applications. In these applications, the reservoir 422 could be relatively large such as between 4 inches and 8 inches, between 6 inches and 12 inches, between 8 inches and 15 inches in diameter and between 3 and 6 inches, between 6 and 12 inches, or between 12 inches and 24 inches in length. Also, the reservoir 422 could have a relatively large capacity such as between 500 mL and 1 L, 1 L and 2.5 L, 2.5 L and 5 L, 5 L and 10 L, and 10 L and 20 L. Also in such applications an run-off hose 432 could optionally be attached to the reservoir 422. The run-off hose 432 could be configured to accommodate any overflow from the assembly. Additionally, this embodiment could be attached as a drain collector on the fuel tank of a mobile vehicle, e.g., a tractor or backhoe, as shown in FIG. 15B. In these embodiments, the assembly 500 could be attached below the fuel filter 502 of the vehicle. Advantageously, in these applications the assembly could be continuously reused which could prevent and/or minimize having to replace a disposable portion of the fuel filter.

In certain embodiments, the apparatus, methods, and systems disclosed can also be used to add and/or remove materials, liquids and/or gases to the system at various times depending on what is desired. The system may be made up of liquids, solid materials and/or gases. In certain aspects, the apparatus, methods, and systems could be used to add additional ingredients. For example, but not limited to, sugar, fruit, molasses, coffee, could be added to the reservoir 40 during secondary bottle fermentation. Thus the additional ingredients could be added in such a manner that they would add flavoring or other properties to the liquid. In another exemplary application, the disclosure could be used to remove excess CO₂ buildup. By installing the reservoir 40 and opening the flow-through passageway 20 with the container 100 in an upright position, the pressure between the container 100 and the reservoir 40 would be equalized, thereby raising the pressure in the reservoir and lowering the pressure in the bottle 100. By subsequently removing and then re-installing the reservoir 40, the pressure could be continuously reduced to a desired amount. Moreover, in alternative embodiments, the reservoir 40 may have a pressure relief valve (for example a float valve or a valve with a preset spring pressure) or a manual relief valve so that the pressure could be capped or adjusted.

Additionally, the exemplary embodiments described above could be modified or added to. For example, a filter could be added to the apparatus in such a manner that only certain substances (e.g., sediment below a certain size) could pass from the container 100 to the reservoir 40. In other embodiments, the filter could also be implemented such that only certain substances would be allowed to pass from the reservoir 40 into the main liquid in the container 100. Any suitable filter could be used such as mesh, paper, cloth, activated charcoal, and cartridge.

Whilst the above has been given by way of illustrative example of the present invention many variations and modifications thereto will be apparent to those skilled in the art without departing from the broad ambit and scope of the invention as herein set forth in the following claims.

The previously described embodiments of the present invention have many advantages. However, the invention does not require that all the advantageous features and advantages described be incorporated into every embodiment.

One advantage is that certain embodiments automatically cause the assembly to open when the reservoir is sufficiently engaged to the body. This may allow quick and easy operation of the apparatus to remove sediment and by-products. It also reduces the need for manual intervention to operate the apparatus and the need to find a place to stow sediment and by-products. Further, the reservoir may easily be removed and emptied at the user's convenience, and then re-installed without risk of causing any spillage of liquids.

Another advantage is that certain embodiments may physically support the container in an upright position. This obviates the need for purchasing separate racks or other equipment that may have been required by previous methods. Accordingly, this may reduce the user's cost and may facilitate bringing home brewing to a wider market.

Yet another advantage is that certain embodiments are reusable and sterilizable. This also reduces the user's cost by allowing continuous reuse without requiring additional investments.

Still another advantage is that certain embodiments are transparent, thereby allowing a user to visually monitor the operation of the apparatus. For example, if used for removing sediment, transparency may allow the user to remove sediment when a certain amount has accrued.

Another advantage is that certain embodiments may be used both for removing sediment and excess carbon dioxide. This may facilitate the brewing process and make it more desirable for home brewers.

Another advantage is that certain embodiments used for removing sediment and water from a hydrocarbon liquid such as fuel or oil prevent and/or minimize leakage from the tank while installed.

Another advantage is that certain embodiments used for removing sediment and water from a hydrocarbon liquid such as fuel or oil prevent and/or minimize leakage from the tank and the assembly when the reservoir is disconnected.

Still another advantage is that certain embodiments used as a detachable assembly or a safety valve for hose lines will prevent and/or minimize the spillage of fuel when the line is attached and/or disconnected.

Another advantage is that certain embodiments may be used to easily added substances, fluids or combinations to a beverage such as beer or wine without having to open the bottle or container.

Another advantage is that certain embodiments used for separating liquids (such as water) and/or sediments (such as sand, grit, or dirt) from a fuel, oil, or other hydrocarbon-based liquid prevent and/or minimize leakage from the tank and the assembly when the reservoir is disconnected.

Another advantage is that certain embodiments used for separating liquids (such as water) and/or sediments (such as sand, grit, or dirt) from a fuel, oil, or other hydrocarbon-based liquid the devices and methods disclosed may be used as a detachable assembly or a safety valve for hose lines will prevent and/or minimize the spillage of fuel when the line is attached and/or disconnected.

Another advantage is that certain embodiments may be used to add substances, liquids, or combinations thereof to a fuel, oil, or other hydrocarbon-based liquid with little spillage of fuel or the materials being added. The invention has been described with reference to particular embodiments. However, it will be readily apparent that it is possible to embody the invention in specific forms other than those of the embodiments described above. The embodiments are merely illustrative and should not be considered restrictive. The scope of the disclosed inventions are given by the appended claims, rather than the preceding description, and all variations and equivalents which fall within the range of the claims are intended to be embraced therein.

The reader's attention is directed to all papers and documents which are filed concurrently with this specification and which are open to public inspection with this specification, and the contents of all such papers and documents are incorporated herein by reference. All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example of a generic series of equivalent or similar features.

1. An apparatus comprising:
a body containing a flow-through passageway adapted to sealably attach a proximal end of the flow-through passageway to an orifice;
a stopper assembly contained within the flow-through passageway adapted to selectively seal the flow through passageway; and
a reservoir adapted to sealably attach to a distal end of the flow-through passageway;
wherein the reservoir is configured to cause the stopper assembly to unseal the flow-through passageway when the reservoir is sealably attached to the distal end of the flow-through passageway.

2. An apparatus comprising:
a body containing a flow-through passageway adapted to sealably attach a proximal end of the flow-through passageway to an orifice of a container;
a stopper assembly contained within the flow-through passageway adapted to selectively seal the flow through passageway; and
a reservoir adapted to sealably attach to a distal end of the flow-through passageway;
wherein the reservoir is configured to cause the stopper assembly to unseal the flow-through passageway when the reservoir is sealably attached to the distal end of the flow-through passageway; and
wherein the reservoir supports the weight of the container so that the container is maintained in an inverted position.

3. An apparatus comprising:
a body containing a flow-through passageway adapted to sealably attach a proximal end of the flow-through passageway to an orifice of a container;
a stopper assembly means for selectively sealing the flow through passageway;
a reservoir means for causing the stopper assembly to unseal the flow-through passageway when the reservoir means is sealably attached to the distal end of the flow-through passageway and for supporting the weight of the container so that the container is maintained in an inverted position.

4. An apparatus comprising:
a body containing a flow-through passageway adapted to attach to the flow-through passageway;
an assembly adapted to selectively seal the flow through passageway;
and a reservoir in communication with flow-through passageway; wherein the reservoir is configured to cause the assembly to unseal the flow-through passageway when the reservoir is attached to the flow-through passageway.

5. The apparatus of claim 1 or 2 wherein the stopper assembly is normally open.

6. The apparatus of claim 1 or 2 wherein the stopper assembly is normally closed.

7. The apparatus of claim 1 or 2 wherein the stopper assembly comprises one of a ball-valve, gate-valve, butterfly valve, globe valve, needle valve, plunger, diaphragm, or sphincter.

8. The apparatus of claim 1 or 2 wherein the stopper assembly is magnetically or electrically actuated.

9. The apparatus of claim 1, 2 or 3 wherein one or more of the body and the reservoir is transparent.

10. The apparatus of claim 1, 2, 3, or 4 wherein the body is made of one or more of a polymeric material, a metal, a wood, a mineral, or a ceramic.

11. The apparatus of claim 1, 2, 3, or 4 wherein the reservoir is made of one or more of a polymeric material, a metal, a wood, a mineral, or a ceramic.

12. The apparatus of claim 1, 2, or 3 wherein the sealable attachment of the proximal end of the flow-through passageway to the orifice of the container comprises a screw thread, hinge members and springs, pushfit, clamp, clip, swivel fitting, or bayonet.

13. The apparatus of claim 1, 2, or 3 wherein the sealable attachment of the proximal end of the flow-through passageway to the orifice of the container comprises a plug or insert.

14. The apparatus of claim 1, 2, or 3 wherein the sealable attachment of the proximal end of the flow-through passageway to the orifice of the container further comprises a sealing member.

15. The apparatus of claim 10 wherein the sealing member comprises an x-ring or an o-ring.

16. The apparatus of claim 1, 2, or 3 further comprising a filter disposed between the proximal end and the distal end of the flow-through passageway.

17. The apparatus of claim 1, 2, 3, or 4 wherein the reservoir has a predetermined volume.

18. A method of separating at least one substance from a liquid in a container using the apparatus of any one of claims 1-18.

19. The apparatus of claim 1, 2, or 3 wherein the sealable attachment of the distal end of the flow-through passageway to the reservoir of the container comprises a screw thread, hinge members and springs, pushfit, clamp, clip, swivel fitting, or bayonet.

20. The apparatus of claim 2, or 3 wherein the container is a bottle containing an alcoholic beverage.

21. The apparatus of claim 1, 2, 3 or wherein the container is a storage tank containing a hydrocarbon-based liquid.
